(19) United States
(12) Patent Application Publication
(10) Pub. No.: US 2024/0064775 A1
(43) Pub. Date: Feb. 22, 2024

(54) SIDELINK CONTROL INFORMATION (SCI) SIGNALING DESIGN FOR SIDELINK IN UNLICENSED BANDS (SL-U) OPERATION

(71) Applicant: Parsa Wireless Communications LLC, Stamford, CT (US)

(72) Inventor: Alireza Babaei, Fairfax, VA (US)

(73) Assignee: Parsa Wireless Communications LLC, Stamford, CT (US)

(21) Appl. No.: 18/234,977

(22) Filed: Aug. 17, 2023

Related U.S. Application Data
(60) Provisional application No. 63/399,858, filed on Aug. 22, 2022.

(51) Int. Cl. H04W 72/25; H04L 5/00; H04W 72/0457

(52) U.S. Cl. CPC H04W 72/25; H04L 5/0053; H04W 72/0457; H04W 74/0808

(57) ABSTRACT

A method of sidelink control information (SCI) transmission includes receiving, by a first user equipment (UE), configuration parameters of an unlicensed carrier for sidelink communications; and first transmitting, by the first UE to a second UE, SCI comprising a field comprising one or more first bits and one or more second bits, wherein: the one or more first bits indicates a set of subchannels of the unlicensed carrier; and the one or more second bits indicate at least one of a starting resource block set (RBS) and a number of consecutive RBSs; and second transmitting, by the first UE to the second UE, sidelink data based on the SCI.

### CROSS-REFERENCE TO RELATED APPLICATIONS

This application claims priority under 35 USC § 119(e) from U.S. Provisional Patent Application No. 63/399,858, filed on Aug. 22, 2022 (“the provisional application”); the content of the provisional patent application is incorporated herein by reference.

### BACKGROUND OF THE INVENTION

The present invention is directed to 5G, which is the 5th generation mobile network. It is a new global wireless standard after 1G, 2G, 3G, and 4G networks. 5G enables networks designed to connect machines, objects and devices.

The invention is more specifically directed to enhancing existing sidelink control information (SCI) signaling when operation in unlicensed bands is configured for sidelink.

### SUMMARY OF THE INVENTION

In an embodiment, the invention provides a method of sidelink control information (SCI) transmission includes receiving, by a first user equipment (UE), configuration parameters of an unlicensed carrier for sidelink communications; and first transmitting, by the first UE to a second UE, SCI comprising a field comprising one or more first bits and one or more second bits, wherein: the one or more first bits indicates a set of subchannels of the unlicensed carrier; and the one or more second bits indicate at least one of a starting resource block set (RBS) and a number of consecutive RBSs; and second transmitting, by the first UE to the second UE, sidelink data based on the SCI.

The received configuration parameters may be transmitted from a base station (BS). The sidelink control information (SCI) may be a first-stage SCI in a multi-stage SCI transmission. The configuration parameters can be for a plurality of carriers comprising the unlicensed carrier. The method may also include the first user equipment (UE) receiving first configuration parameters indicating a plurality of sets of subchannels, wherein the one or more first bits point to or provide an index to the set of subchannels in the plurality of sets of subchannels. The configuration parameters may comprise first configuration parameters of a bandwidth part (BWP) of the unlicensed carrier. The configuration parameters may indicate one or more of configuration of usage, subcarrier spacing (SCS), resource pool, control channel structure and access rules.

The configuration parameters may indicate one or more resource pools (RPs) associated with the unlicensed carrier or associated with a bandwidth part (BWP) of the unlicensed carrier. A resource pool (RP) of the one or more resource pools (RPs) may comprise one or more resource block sets (RBSs). Frequency domain block interleaving may be applied to a resource block set (RBS) of the one or more RBSs. One or more first resource block sets (RBSs) of the one or more RBSs, for which a listen-before-talk (LBT) process is applied, may be aligned with a 20 MHz subband for the LBT process. The one or more second bits may indicate reservation of the consecutive resource block sets (RBSs). The reservation of the consecutive resource block sets (RBSs) may be based on a unit of symbols. Transmission of the side control information (SCI) may be via pre-configured resources. Transmitting the side control information (SCI) may be via configurable resources.

The first user equipment (UE) may further receive configuration parameters indicating the configurable resources. The configuration parameters may be received by the first user equipment (UE) via one or more radio resource control (RRC) messages. The unlicensed carrier may be shared between a Uu interface and a sidelink. In the method, the Uu interface may be between the first user equipment (UE) and a base station; and the sidelink may be between the first UE and a second UE. A first configuration parameter of the configuration parameters may indicate a bitmap; and the bitmap may indicate first time domain resources that the unlicensed carrier, or a first resource pool (RP) of the unlicensed carrier, is reserved for the Uu interface and second time domain resources that the unlicensed carrier, or the first RP, is reserved for the sidelink.

The method may further comprise transmitting, by the first user equipment (UE), a plurality of transport blocks based on a single downlink control information (DCI). The plurality of transport blocks may be transmitted using the same modulation and coding scheme (MCS). The method can also further comprise determining a plurality of hybrid automatic repeat request (HARQ) process numbers for the plurality of transport blocks. The downlink control information (DCI) may comprise a single hybrid automatic repeat request (HARQ) process number field and determining the plurality of HARQ process numbers may be based on the value of the HARQ process number field. The method can include determining a plurality of redundancy versions (RVs) for the plurality of transport blocks.

The downlink control information (DCI) may comprise a single redundancy version (RV) field, and wherein the determining the plurality of RVs are based on the value of the RV field. For that matter, the method may further comprise reserving, by the first user equipment (UE), a plurality of resources within a time window. Preferably, the time window is based on a channel occupancy time (COT). The channel occupancy time (COT) may be determined based on a listen-before-talk (LBT) process being successful. The plurality of resources may be within a single channel occupancy time (COT). A first-stage side control information (SCI) may indicate multiple slots to enable back-to-back transmission of multiple transport blocks.

In the method, a first-stage side control information (SCI) may indicate reservation of multiple back-to-back slots; and a second-stage SCI may indicate hybrid automatic repeat request (HARQ) process numbers, redundancy versions (RVs) and new data indicators (NDIs) for multiple transport blocks. The plurality of resources may be distributed or otherwise available across multiple channel occupancy times (COTs). A time window, comprising the plurality of resources, may be smaller than a threshold. In the method, the second transmitting of the sidelink data is in response to a listen-before-talk (LBT) process; and one or more parameters of the LBT process is based on a channel access priority class associated with a physical sidelink shared channel used for transmission of the transport block.

### BRIEF DESCRIPTION OF THE DRAWINGS

FIG. 1 shows an example of a system of mobile communications according to some aspects of some of various exemplary embodiments of the present disclosure.

FIG. 2A and FIG. 2B show examples of radio protocol stacks for user plane and control plane, respectively, according to some aspects of some of various exemplary embodiments of the present disclosure.

FIG. 3A, FIG. 3B and FIG. 3C show example mappings between logical channels and transport channels in downlink, uplink and sidelink, respectively, according to some aspects of some of various exemplary embodiments of the present disclosure.

FIG. 4A, FIG. 4B and FIG. 4C show example mappings between transport channels and physical channels in downlink, uplink and sidelink, respectively, according to some aspects of some of various exemplary embodiments of the present disclosure.

FIG. 5A, FIG. 5B, FIG. 5C and FIG. 5D show examples of radio protocol stacks for NR sidelink communication according to some aspects of some of various exemplary embodiments of the present disclosure.

FIG. 6 shows example physical signals in downlink, uplink and sidelink according to some aspects of some of various exemplary embodiments of the present disclosure.

FIG. 7 shows examples of Radio Resource Control (RRC) states and transitioning between different RRC states according to some aspects of some of various exemplary embodiments of the present disclosure.

FIG. 8 shows example frame structure and physical resources according to some aspects of some of various exemplary embodiments of the present disclosure.

FIG. 9 shows example component carrier configurations in different carrier aggregation scenarios according to some aspects of some of various exemplary embodiments of the present disclosure.

FIG. 10 shows example bandwidth part configuration and switching according to some aspects of some of various exemplary embodiments of the present disclosure.

FIG. 11 shows example four-step contention-based and contention-free random access processes according to some aspects of some of various exemplary embodiments of the present disclosure.

FIG. 12 shows example two-step contention-based and contention-free random access processes according to some aspects of some of various exemplary embodiments of the present disclosure.

FIG. 13 shows example time and frequency structure of Synchronization Signal and Physical Broadcast Channel (PBCH) Block (SSB) according to some aspects of some of various exemplary embodiments of the present disclosure.

FIG. 14 shows example SSB burst transmissions according to some aspects of some of various exemplary embodiments of the present disclosure.

FIG. 15 shows example components of a user equipment and a base station for transmission and/or reception according to some aspects of some of various exemplary embodiments of the present disclosure.

FIG. 16 shows an example of sidelink (SL) resource pool (RP), Subchannels aligned with resource block (RB) sets and Interlaced Blocks according to some aspects of some of various exemplary embodiments of the present disclosure.

FIG. 17 shows an example frequency domain indexing for resource reservation in 1st stage side control information (SCI) according to some aspects of some of various exemplary embodiments of the present disclosure.

FIG. 18 shows an example Single downlink control information (DCI) for Mode 1 sidelink in unlicensed bands (SL-U) Multi-slot Dynamic Resource Allocation according to some aspects of some of various exemplary embodiments of the present disclosure.

FIG. 19 shows an example SCI Signaling with Intra and Inter CoT Resource Reservation according to some aspects of some of various exemplary embodiments of the present disclosure.

FIG. 20 shows an example SCI signaling for Indicating TB Re-Transmission, New TB Transmissions and Reserving/Un-Reserving Time Resources according to some aspects of some of various exemplary embodiments of the present disclosure.

FIG. 21 shows an example process according to some aspects of some of various exemplary embodiments of the present disclosure.

### DETAILED DESCRIPTION

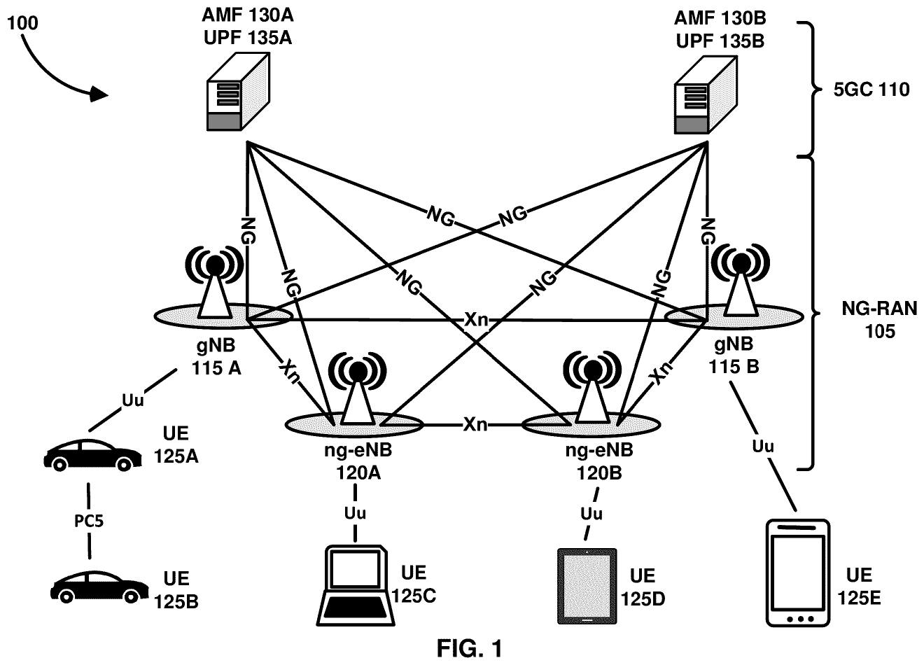

FIG. 1 shows an example of a system of mobile communications 100 according to some aspects of some of various exemplary embodiments of the present disclosure. The system of mobile communication 100 may be operated by a wireless communications system operator such as a Mobile Network Operator (MNO), a private network operator, a Multiple System Operator (MSO), an Internet of Things (IOT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial IOT (HOT), etc.

The system of mobile communications 100 may enable various types of applications with different requirements in terms of latency, reliability, throughput, etc. Example supported applications include enhanced Mobile Broadband (eMBB), Ultra-Reliable Low-Latency Communications (URLLC), and massive Machine Type Communications (mMTC). eMBB may support stable connections with high peak data rates, as well as moderate rates for cell-edge users. URLLC may support application with strict requirements in terms of latency and reliability and moderate requirements in terms of data rate. Example mMTC application includes a network of a massive number of IoT devices, which are only sporadically active and send small data payloads.

The system of mobile communications 100 may include a Radio Access Network (RAN) portion and a core network portion. The example shown in FIG. 1 illustrates a Next Generation RAN (NG-RAN) 105 and a 5G Core Network (5GC) 110 as examples of the RAN and core network, respectively. Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), etc. Other examples of core network include Evolved Packet Core (EPC), UMTS Core Network (UCN), etc. The RAN implements a Radio Access Technology (RAT) and resides between User Equipments (UEs) 125 and the core network. Examples of such RATs include New Radio (NR), Long Term Evolution (LTE) also known as Evolved Universal Terrestrial Radio Access (EUTRA), Universal Mobile Telecommunication System (UMTS), etc. The RAT of the example system of mobile communications 100 may be NR. The core network resides between the RAN and one or more external networks (e.g., data networks) and is responsible for functions such as mobility management, authentication, session management, setting up bearers and application of different Quality of Services (QoSs). The functional layer between the UE 125 and the RAN (e.g., the NG-RAN 105) may be referred to as Access Stratum (AS) and the functional layer between the UE 125 and the core network (e.g., the 5GC 110) may be referred to as Non-access Stratum (NAS).

The UEs 125 may include wireless transmission and reception means for communications with one or more nodes in the RAN, one or more relay nodes, or one or more other UEs, etc. Examples of UEs include, but are not limited to, smartphones, tablets, laptops, computers, wireless transmission and/or reception units in a vehicle, V2X or Vehicle to Vehicle (V2V) devices, wireless sensors, IoT devices, IIOT devices, etc. Other names may be used for UEs such as a Mobile Station (MS), terminal equipment, terminal node, client device, mobile device, etc.

The RAN may include nodes (e.g., base stations) for communications with the UEs. For example, the NG-RAN 105 of the system of mobile communications 100 may comprise nodes for communications with the UEs 125. Different names for the RAN nodes may be used, for example depending on the RAT used for the RAN. A RAN node may be referred to as Node B (NB) in a RAN that uses the UMTS RAT. A RAN node may be referred to as an evolved Node B (eNB) in a RAN that uses LTE/EUTRA RAT. For the illustrative example of the system of mobile communications 100 in FIG. 1, the nodes of an NG-RAN 105 may be either a next generation Node B (gNB) 115 or a next generation evolved Node B (ng-eNB) 120. In this specification, the terms base station, RAN node, gNB and ng-eNB may be used interchangeably. The gNB 115 may provide NR user plane and control plane protocol terminations towards the UE 125. The ng-eNB 120 may provide E-UTRA user plane and control plane protocol terminations towards the UE 125. An interface between the gNB 115 and the UE 125 or between the ng-eNB 120 and the UE 125 may be referred to as a Uu interface. The Uu interface may be established with a user plane protocol stack and a control plane protocol stack. For a Uu interface, the direction from the base station (e.g., the gNB 115 or the ng-eNB 120) to the UE 125 may be referred to as downlink and the direction from the UE 125 to the base station (e.g., gNB 115 or ng-eNB 120) may be referred to as uplink.

The gNBs 115 and ng-eNBs 120 may be interconnected with each other by means of an Xn interface. The Xn interface may comprise an Xn User plane (Xn-U) interface and an Xn Control plane (Xn-C) interface. The transport network layer of the Xn-U interface may be built on Internet Protocol (IP) transport and GPRS Tunneling Protocol (GTP) may be used on top of User Datagram Protocol (UDP)/IP to carry the user plane protocol data units (PDUs). Xn-U may provide non-guaranteed delivery of user plane PDUs and may support data forwarding and flow control. The transport network layer of the Xn-C interface may be built on Stream Control Transport Protocol (SCTP) on top of IP. The application layer signaling protocol may be referred to as XnAP (Xn Application Protocol). The SCTP layer may provide the guaranteed delivery of application layer messages. In the transport IP layer, point-to-point transmission may be used to deliver the signaling PDUs. The Xn-C interface may support Xn interface management, UE mobility management, including context transfer and RAN paging, and dual connectivity.

The gNBs 115 and ng-eNBs 120 may also be connected to the 5GC 110 by means of the NG interfaces, more specifically to an Access and Mobility Management Function (AMF) 130 of the 5GC 110 by means of the NG-C interface and to a User Plane Function (UPF) 135 of the 5GC 110 by means of the NG-U interface. The transport network layer of the NG-U interface may be built on IP transport and GTP protocol may be used on top of UDP/IP to carry the user plane PDUs between the NG-RAN node (e.g., gNB 115 or ng-eNB 120) and the UPF 135. NG-U may provide non-guaranteed delivery of user plane PDUs between the NG-RAN node and the UPF. The transport network layer of the NG-C interface may be built on IP transport. For the reliable transport of signaling messages, SCTP may be added on top of IP. The application layer signaling protocol may be referred to as NGAP (NG Application Protocol). The SCTP layer may provide guaranteed delivery of application layer messages. In the transport, IP layer point-to-point transmission may be used to deliver the signaling PDUs. The NG-C interface may provide the following functions: NG interface management; UE context management; UE mobility management; transport of NAS messages; paging; PDU Session Management; configuration transfer; and warning message transmission.

The gNB 115 or the ng-eNB 120 may host one or more of the following functions: Radio Resource Management functions such as Radio Bearer Control, Radio Admission Control, Connection Mobility Control, Dynamic allocation of resources to UEs in both uplink and downlink (e.g., scheduling); IP and Ethernet header compression, encryption and integrity protection of data; Selection of an AMF at UE attachment when no routing to an AMF can be determined from the information provided by the UE; Routing of User Plane data towards UPF(s); Routing of Control Plane information towards AMF; Connection setup and release; Scheduling and transmission of paging messages; Scheduling and transmission of system broadcast information (e.g., originated from the AMF); Measurement and measurement reporting configuration for mobility and scheduling; Transport level packet marking in the uplink; Session Management; Support of Network Slicing; QoS Flow management and mapping to data radio bearers; Support of UEs in RRC Inactive state; Distribution function for NAS messages; Radio access network sharing; Dual Connectivity; Tight interworking between NR and E-UTRA; and Maintaining security and radio configuration for User Plane 5G system (5GS) Cellular IoT (CIoT) Optimization.

The AMF 130 may host one or more of the following functions: NAS signaling termination; NAS signaling security; AS Security control; Inter CN node signaling for mobility between 3GPP access networks; Idle mode UE Reachability (including control and execution of paging retransmission); Registration Area management; Support of intra-system and inter-system mobility; Access Authentication; Access Authorization including check of roaming rights; Mobility management control (subscription and policies); Support of Network Slicing; Session Management Function (SMF) selection; Selection of 5GS CIoT optimizations.

The UPF 135 may host one or more of the following functions: Anchor point for Intra-/Inter-RAT mobility (when applicable); External PDU session point of interconnect to Data Network; Packet routing & forwarding; Packet inspection and User plane part of Policy rule enforcement; Traffic usage reporting; Uplink classifier to support routing traffic flows to a data network; Branching point to support multi-homed PDU session; QoS handling for user plane, e.g. packet filtering, gating, UL/DL rate enforcement; Uplink Traffic verification (Service Data Flow (SDF) to QoS flow mapping); Downlink packet buffering and downlink data notification triggering.

As shown in FIG. 1, the NG-RAN 105 may support the PC5 interface between two UEs 125 (e.g., UE 125A and UE125B). In the PC5 interface, the direction of communications between two UEs (e.g., from UE 125A to UE 125B or vice versa) may be referred to as sidelink. Sidelink transmission and reception over the PC5 interface may be supported when the UE 125 is inside NG-RAN 105 coverage, irrespective of which RRC state the UE is in, and when the UE 125 is outside NG-RAN 105 coverage. Support of V2X services via the PC5 interface may be provided by NR sidelink communication and/or V2X sidelink communication.

PC5-S signaling may be used for unicast link establishment with Direct Communication Request/Accept message. A UE may self-assign its source Layer-2 ID for the PC5 unicast link for example based on the V2X service type. During unicast link establishment procedure, the UE may send its source Layer-2 ID for the PC5 unicast link to the peer UE, e.g., the UE for which a destination ID has been received from the upper layers. A pair of source Layer-2 ID and destination Layer-2 ID may uniquely identify a unicast link. The receiving UE may verify that the said destination ID belongs to it and may accept the Unicast link establishment request from the source UE. During the PC5 unicast link establishment procedure, a PC5-RRC procedure on the Access Stratum may be invoked for the purpose of UE sidelink context establishment as well as for AS layer configurations, capability exchange etc. PC5-RRC signaling may enable exchanging UE capabilities and AS layer configurations such as Sidelink Radio Bearer configurations between pair of UEs for which a PC5 unicast link is established.

NR sidelink communication may support one of three types of transmission modes (e.g., Unicast transmission, Groupcast transmission, and Broadcast transmission) for a pair of a Source Layer-2 ID and a Destination Layer-2 ID in the AS. The Unicast transmission mode may be characterized by: Support of one PC5-RRC connection between peer UEs for the pair; Transmission and reception of control information and user traffic between peer UEs in sidelink; Support of sidelink HARQ feedback; Support of sidelink transmit power control; Support of RLC Acknowledged Mode (AM); and Detection of radio link failure for the PC5-RRC connection. The Groupcast transmission may be characterized by: Transmission and reception of user traffic among UEs belonging to a group in sidelink; and Support of sidelink HARQ feedback. The Broadcast transmission may be characterized by: Transmission and reception of user traffic among UEs in sidelink.

A Source Layer-2 ID, a Destination Layer-2 ID and a PC5 Link Identifier may be used for NR sidelink communication. The Source Layer-2 ID may be a link-layer identity that identifies a device or a group of devices that are recipients of sidelink communication frames. The Destination Layer-2 ID may be a link-layer identity that identifies a device that originates sidelink communication frames. In some examples, the Source Layer-2 ID and the Destination Layer-2 ID may be assigned by a management function in the Core Network. The Source Layer-2 ID may identify the sender of the data in NR sidelink communication. The Source Layer-2 ID may be 24 bits long and may be split in the MAC layer into two bit strings: One bit string may be the LSB part (8 bits) of Source Layer-2 ID and forwarded to physical layer of the sender. This may identify the source of the intended data in sidelink control information and may be used for filtering of packets at the physical layer of the receiver; and the Second bit string may be the MSB part (16 bits) of the Source Layer-2 ID and may be carried within the Medium Access Control (MAC) header. This may be used for filtering of packets at the MAC layer of the receiver. The Destination Layer-2 ID may identify the target of the data in NR sidelink communication. For NR sidelink communication, the Destination Layer-2 ID may be 24 bits long and may be split in the MAC layer into two bit strings: One bit string may be the LSB part (16 bits) of Destination Layer-2 ID and forwarded to physical layer of the sender. This may identify the target of the intended data in sidelink control information and may be used for filtering of packets at the physical layer of the receiver; and the Second bit string may be the MSB part (8 bits) of the Destination Layer-2 ID and may be carried within the MAC header. This may be used for filtering of packets at the MAC layer of the receiver. The PC5 Link Identifier may uniquely identify the PC5 unicast link in a UE for the lifetime of the PC5 unicast link. The PC5 Link Identifier may be used to indicate the PC5 unicast link whose sidelink Radio Link failure (RLF) declaration was made and PC5-RRC connection was released.

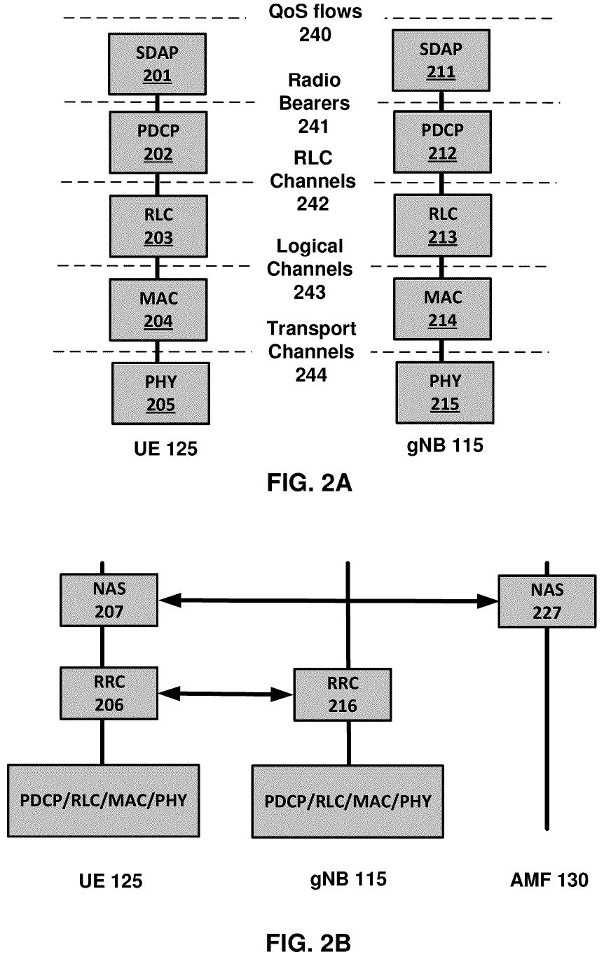

FIG. 2A and FIG. 2B show examples of radio protocol stacks for user plane and control plane, respectively, according to some aspects of some of various exemplary embodiments of the present disclosure. As shown in FIG. 2A, the protocol stack for the user plane of the Uu interface (between the UE 125 and the gNB 115) includes Service Data Adaptation Protocol (SDAP) 201 and SDAP 211, Packet Data Convergence Protocol (PDCP) 202 and PDCP 212, Radio Link Control (RLC) 203 and RLC 213, MAC 204 and MAC 214 sublayers of layer 2 and Physical (PHY) 205 and PHY 215 layer (layer 1 also referred to as L1).

The PHY 205 and PHY 215 offer transport channels 244 to the MAC 204 and MAC 214 sublayer. The MAC 204 and MAC 214 sublayer offer logical channels 243 to the RLC 203 and RLC 213 sublayer. The RLC 203 and RLC 213 sublayer offer RLC channels 242 to the PDCP 202 and PCP 212 sublayer. The PDCP 202 and PDCP 212 sublayer offer radio bearers 241 to the SDAP 201 and SDAP 211 sublayer. Radio bearers may be categorized into two groups: Data Radio Bearers (DRBs) for user plane data and Signaling Radio Bearers (SRBs) for control plane data. The SDAP 201 and SDAP 211 sublayer offers QoS flows 240 to 5GC.

The main services and functions of the MAC 204 or MAC 214 sublayer include: mapping between logical channels and transport channels; Multiplexing/demultiplexing of MAC Service Data Units (SDUs) belonging to one or different logical channels into/from Transport Blocks (TB) delivered to/from the physical layer on transport channels; Scheduling information reporting; Error correction through Hybrid Automatic Repeat Request (HARQ) (one HARQ entity per cell in case of carrier aggregation (CA)); Priority handling between UEs by means of dynamic scheduling; Priority handling between logical channels of one UE by means of Logical Channel Prioritization (LCP); Priority handling between overlapping resources of one UE; and Padding. A single MAC entity may support multiple numerologies, transmission timings and cells. Mapping restrictions in logical channel prioritization control which numerology(ies), cell(s), and transmission timing(s) a logical channel may use.

The HARQ functionality may ensure delivery between peer entities at Layer 1. A single HARQ process may support one TB when the physical layer is not configured for downlink/uplink spatial multiplexing, and when the physical layer is configured for downlink/uplink spatial multiplexing, a single HARQ process may support one or multiple TBs.

The RLC 203 or RLC 213 sublayer may support three transmission modes: Transparent Mode (TM); Unacknowledged Mode (UM); and Acknowledged Mode (AM). The RLC configuration may be per logical channel with no dependency on numerologies and/or transmission durations, and Automatic Repeat Request (ARQ) may operate on any of the numerologies and/or transmission durations the logical channel is configured with.

The main services and functions of the RLC 203 or RLC 213 sublayer depend on the transmission mode (e.g., TM, UM or AM) and may include: Transfer of upper layer PDUs; Sequence numbering independent of the one in PDCP (UM and AM); Error Correction through ARQ (AM only); Segmentation (AM and UM) and re-segmentation (AM only) of RLC SDUs; Reassembly of SDU (AM and UM); Duplicate Detection (AM only); RLC SDU discard (AM and UM); RLC re-establishment; and Protocol error detection (AM only).

The automatic repeat request within the RLC 203 or RLC 213 sublayer may have the following characteristics: ARQ retransmits RLC SDUs or RLC SDU segments based on RLC status reports; Polling for RLC status report may be used when needed by RLC; RLC receiver may also trigger RLC status report after detecting a missing RLC SDU or RLC SDU segment.

The main services and functions of the PDCP 202 or PDCP 212 sublayer may include: Transfer of data (user plane or control plane); Maintenance of PDCP Sequence Numbers (SNs); Header compression and decompression using the Robust Header Compression (ROHC) protocol; Header compression and decompression using EHC protocol; Ciphering and deciphering; Integrity protection and integrity verification; Timer based SDU discard; Routing for split bearers; Duplication; Reordering and in-order delivery; Out-of-order delivery; and Duplicate discarding.

The main services and functions of SDAP 201 or SDAP 211 include: Mapping between a QoS flow and a data radio bearer; and Marking QoS Flow ID (QFI) in both downlink and uplink packets. A single protocol entity of SDAP may be configured for each individual PDU session.

As shown in FIG. 2B, the protocol stack of the control plane of the Uu interface (between the UE 125 and the gNB 115) includes PHY layer (layer 1), and MAC, RLC and PDCP sublayers of layer 2 as described above and in addition, the RRC 206 sublayer and RRC 216 sublayer. The main services and functions of the RRC 206 sublayer and the RRC 216 sublayer over the Uu interface include: Broadcast of System Information related to AS and NAS; Paging initiated by 5GC or NG-RAN; Establishment, maintenance and release of an RRC connection between the UE and NG-RAN (including Addition, modification and release of carrier aggregation; and Addition, modification and release of Dual Connectivity in NR or between E-UTRA and NR); Security functions including key management; Establishment, configuration, maintenance and release of SRBs and DRBs; Mobility functions (including Handover and context transfer; UE cell selection and reselection and control of cell selection and reselection; and Inter-RAT mobility); QoS management functions; UE measurement reporting and control of the reporting; Detection of and recovery from radio link failure; and NAS message transfer to/from NAS from/to UE. The NAS 207 and NAS 227 layer is a control protocol (terminated in AMF on the network side) that performs the functions such as authentication, mobility management, security control, etc.

The sidelink specific services and functions of the RRC sublayer over the Uu interface include: Configuration of sidelink resource allocation via system information or dedicated signaling; Reporting of UE sidelink information; Measurement configuration and reporting related to sidelink; and Reporting of UE assistance information for SL traffic pattern(s).

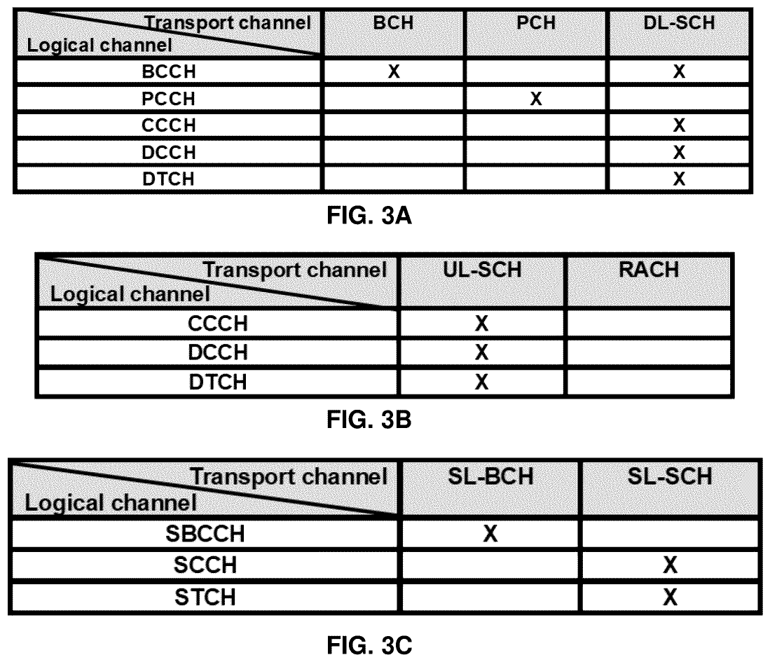

FIG. 3A, FIG. 3B and FIG. 3C show example mappings between logical channels and transport channels in downlink, uplink and sidelink, respectively, according to some aspects of some of various exemplary embodiments of the present disclosure. Different kinds of data transfer services may be offered by MAC. Each logical channel type may be defined by what type of information is transferred. Logical channels may be classified into two groups: Control Channels and Traffic Channels. Control channels may be used for the transfer of control plane information only. The Broadcast Control Channel (BCCH) is a downlink channel for broadcasting system control information. The Paging Control Channel (PCCH) is a downlink channel that carries paging messages. The Common Control Channel (CCCH) is channel for transmitting control information between UEs and network. This channel may be used for UEs having no RRC connection with the network. The Dedicated Control Channel (DCCH) is a point-to-point bi-directional channel that transmits dedicated control information between a UE and the network and may be used by UEs having an RRC connection. Traffic channels may be used for the transfer of user plane information only. The Dedicated Traffic Channel (DTCH) is a point-to-point channel, dedicated to one UE, for the transfer of user information. A DTCH may exist in both uplink and downlink. Sidelink Control Channel (SCCH) is a sidelink channel for transmitting control information (e.g., PC5-RRC and PC5-S messages) from one UE to other UE(s). Sidelink Traffic Channel (STCH) is a sidelink channel for transmitting user information from one UE to other UE(s). Sidelink Broadcast Control Channel (SBCCH) is a sidelink channel for broadcasting sidelink system information from one UE to other UE(s).

The downlink transport channel types include Broadcast Channel (BCH), Downlink Shared Channel (DL-SCH), and Paging Channel (PCH). The BCH may be characterized by: fixed, pre-defined transport format; and requirement to be broadcast in the entire coverage area of the cell, either as a single message or by beamforming different BCH instances. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; and the support for UE Discontinuous Reception (DRX) to enable UE power saving. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; support for UE discontinuous reception (DRX) to enable UE power saving. The PCH may be characterized by: support for UE discontinuous reception (DRX) to enable UE power saving (DRX cycle is indicated by the network to the UE); requirement to be broadcast in the entire coverage area of the cell, either as a single message or by beamforming different BCH instances; mapped to physical resources which can be used dynamically also for traffic/other control channels.

In downlink, the following connections between logical channels and transport channels may exist: BCCH may be mapped to BCH; BCCH may be mapped to DL-SCH; PCCH may be mapped to PCH; CCCH may be mapped to DL-SCH; DCCH may be mapped to DL-SCH; and DTCH may be mapped to DL-SCH.

The uplink transport channel types include Uplink Shared Channel (UL-SCH) and Random Access Channel(s) (RACH). The UL-SCH may be characterized by possibility to use beamforming; support for dynamic link adaptation by varying the transmit power and potentially modulation and coding; support for HARQ: support for both dynamic and semi-static resource allocation. The RACH may be characterized by limited control information; and collision risk.

In Uplink, the following connections between logical channels and transport channels may exist: CCCH may be mapped to UL-SCH; DCCH may be mapped to UL-SCH; and DTCH may be mapped to UL-SCH.

The sidelink transport channel types include: Sidelink broadcast channel (SL-BCH) and Sidelink shared channel (SL-SCH). The SL-BCH may be characterized by pre-defined transport format. The SL-SCH may be characterized by support for unicast transmission, groupcast transmission and broadcast transmission; support for both UE autonomous resource selection and scheduled resource allocation by NG-RAN; support for both dynamic and semi-static resource allocation when UE is allocated resources by the NG-RAN; support for HARQ; and support for dynamic link adaptation by varying the transmit power, modulation and coding.

In the sidelink, the following connections between logical channels and transport channels may exist: SCCH may be mapped to SL-SCH; STCH may be mapped to SL-SCH; and SBCCH may be mapped to SL-BCH.

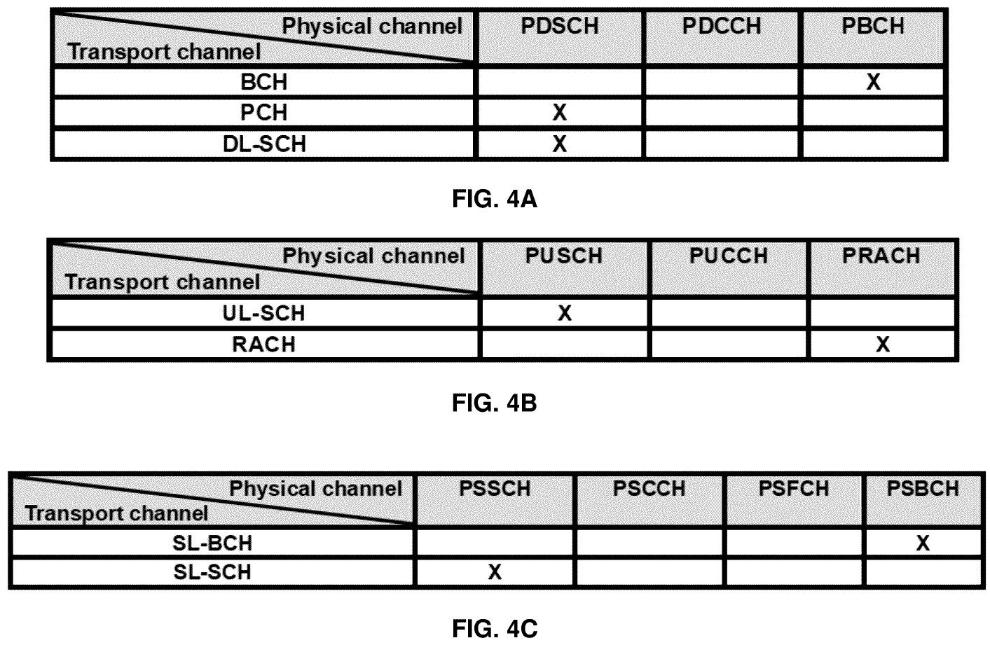

FIG. 4A, FIG. 4B and FIG. 4C show example mappings between transport channels and physical channels in downlink, uplink and sidelink, respectively, according to some aspects of some of various exemplary embodiments of the present disclosure. The physical channels in downlink include Physical Downlink Shared Channel (PDSCH), Physical Downlink Control Channel (PDCCH) and Physical Broadcast Channel (PBCH). The PCH and DL-SCH transport channels are mapped to the PDSCH. The BCH transport channel is mapped to the PBCH. A transport channel is not mapped to the PDCCH but Downlink Control Information (DCI) is transmitted via the PDCCH.

The physical channels in the uplink include Physical Uplink Shared Channel (PUSCH), Physical Uplink Control Channel (PUCCH) and Physical Random Access Channel (PRACH). The UL-SCH transport channel may be mapped to the PUSCH and the RACH transport channel may be mapped to the PRACH. A transport channel is not mapped to the PUCCH but Uplink Control Information (UCI) is transmitted via the PUCCH.

The physical channels in the sidelink include Physical Sidelink Shared Channel (PSSCH), Physical Sidelink Control Channel (PSCCH), Physical Sidelink Feedback Channel (PSFCH) and Physical Sidelink Broadcast Channel (PSBCH). The Physical Sidelink Control Channel (PSCCH) may indicate resource and other transmission parameters used by a UE for PSSCH. The Physical Sidelink Shared Channel (PSSCH) may transmit the TBs of data themselves, and control information for HARQ procedures and CSI feedback triggers, etc. At least 6 OFDM symbols within a slot may be used for PSSCH transmission. Physical Sidelink Feedback Channel (PSFCH) may carry the HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. The SL-SCH transport channel may be mapped to the PSSCH. The SL-BCH may be mapped to PSBCH. No transport channel is mapped to the PSFCH but Sidelink Feedback Control Information (SFCI) may be mapped to the PSFCH. No transport channel is mapped to PSCCH but Sidelink Control Information (SCI) may mapped to the PSCCH.

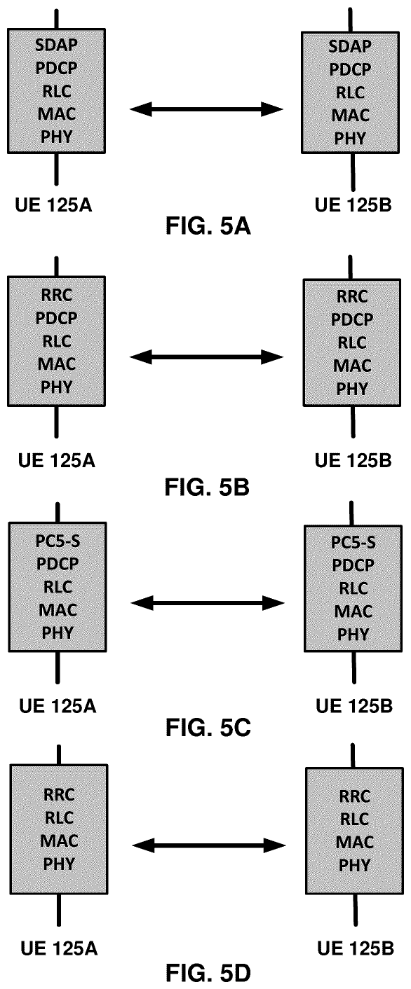

FIG. 5A, FIG. 5B, FIG. 5C and FIG. 5D show examples of radio protocol stacks for NR sidelink communication according to some aspects of some of various exemplary embodiments of the present disclosure. The AS protocol stack for user plane in the PC5 interface (i.e., for STCH) may consist of SDAP, PDCP, RLC and MAC sublayers, and the physical layer. The protocol stack of user plane is shown in FIG. 5A. The AS protocol stack for SBCCH in the PC5 interface may consist of RRC, RLC, MAC sublayers, and the physical layer as shown below in FIG. 5B. For support of PC5-S protocol, PC5-S is located on top of PDCP, RLC and MAC sublayers, and the physical layer in the control plane protocol stack for SCCH for PC5-S, as shown in FIG. 5C. The AS protocol stack for the control plane for SCCH for RRC in the PC5 interface consists of RRC, PDCP, RLC and MAC sublayers, and the physical layer. The protocol stack of control plane for SCCH for RRC is shown in FIG. 5D.

The Sidelink Radio Bearers (SLRBs) may be categorized into two groups: Sidelink Data Radio Bearers (SL DRB) for user plane data and Sidelink Signaling Radio Bearers (SL SRB) for control plane data. Separate SL SRBs using different SCCHs may be configured for PC5-RRC and PC5-S signaling, respectively.

The MAC sublayer may provide the following services and functions over the PC5 interface: Radio resource selection; Packet filtering; Priority handling between uplink and sidelink transmissions for a given UE; and Sidelink CSI reporting. With logical channel prioritization restrictions in MAC, only sidelink logical channels belonging to the same destination may be multiplexed into a MAC PDU for every unicast, groupcast and broadcast transmission which may be associated to the destination. For packet filtering, a SL-SCH MAC header including portions of both Source Layer-2 ID and a Destination Layer-2 ID may be added to a MAC PDU. The Logical Channel Identifier (LCID) included within a MAC subheader may uniquely identify a logical channel within the scope of the Source Layer-2 ID and Destination Layer-2 ID combination.

The services and functions of the RLC sublayer may be supported for sidelink. Both RLC Unacknowledged Mode (UM) and Acknowledged Mode (AM) may be used in unicast transmission while only UM may be used in groupcast or broadcast transmission. For UM, only unidirectional transmission may be supported for groupcast and broadcast.

The services and functions of the PDCP sublayer for the Uu interface may be supported for sidelink with some restrictions: Out-of-order delivery may be supported only for unicast transmission; and Duplication may not be supported over the PC5 interface.

The SDAP sublayer may provide the following service and function over the PC5 interface: Mapping between a QoS flow and a sidelink data radio bearer. There may be one SDAP entity per destination for one of unicast, groupcast and broadcast which is associated to the destination.

The RRC sublayer may provide the following services and functions over the PC5 interface: Transfer of a PC5-RRC message between peer UEs; Maintenance and release of a PC5-RRC connection between two UEs; and Detection of sidelink radio link failure for a PC5-RRC connection based on indication from MAC or RLC. A PC5-RRC connection may be a logical connection between two UEs for a pair of Source and Destination Layer-2 IDs which may be considered to be established after a corresponding PC5 unicast link is established. There may be one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages may be used for a UE to transfer UE capability and sidelink configuration including SL-DRB configuration to the peer UE. Both peer UEs may exchange their own UE capability and sidelink configuration using separate bi-directional procedures in both sidelink directions.

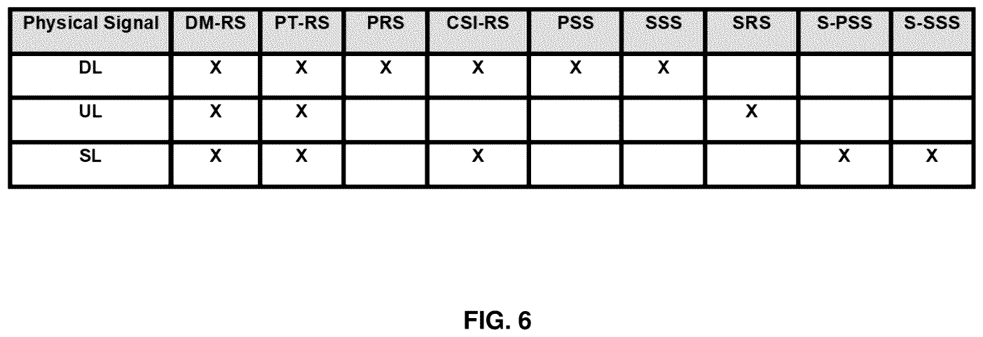

FIG. 6 shows example physical signals in downlink, uplink and sidelink according to some aspects of some of various exemplary embodiments of the present disclosure. The Demodulation Reference Signal (DM-RS) may be used in downlink, uplink and sidelink and may be used for channel estimation. DM-RS is a UE-specific reference signal and may be transmitted together with a physical channel in downlink, uplink or sidelink and may be used for channel estimation and coherent detection of the physical channel. The Phase Tracking Reference Signal (PT-RS) may be used in downlink, uplink and sidelink and may be used for tracking the phase and mitigating the performance loss due to phase noise. The PT-RS may be used mainly to estimate and minimize the effect of Common Phase Error (CPE) on system performance. Due to the phase noise properties, PT-RS signal may have a low density in the frequency domain and a high density in the time domain. PT-RS may occur in combination with DM-RS and when the network has configured PT-RS to be present. The Positioning Reference Signal (PRS) may be used in downlink for positioning using different positioning techniques. PRS may be used to measure the delays of the downlink transmissions by correlating the received signal from the base station with a local replica in the receiver. The Channel State Information Reference Signal (CSI-RS) may be used in downlink and sidelink. CSI-RS may be used for channel state estimation, Reference Signal Received Power (RSRP) measurement for mobility and beam management, time/frequency tracking for demodulation among other uses. CSI-RS may be configured UE-specifically but multiple users may share the same CSI-RS resource. The UE may determine CSI reports and transit them in the uplink to the base station using PUCCH or PUSCH. The CSI report may be carried in a sidelink MAC CE. The Primary Synchronization Signal (PSS) and the Secondary Synchronization Signal (SSS) may be used for radio fame synchronization. The PSS and SSS may be used for the cell search procedure during the initial attach or for mobility purposes. The Sounding Reference Signal (SRS) may be used in uplink for uplink channel estimation. Similar to CSI-RS, the SRS may serve as QCL reference for other physical channels such that they can be configured and transmitted quasi-collocated with SRS. The Sidelink PSS (S-PSS) and Sidelink SSS (S-SSS) may be used in sidelink for sidelink synchronization.

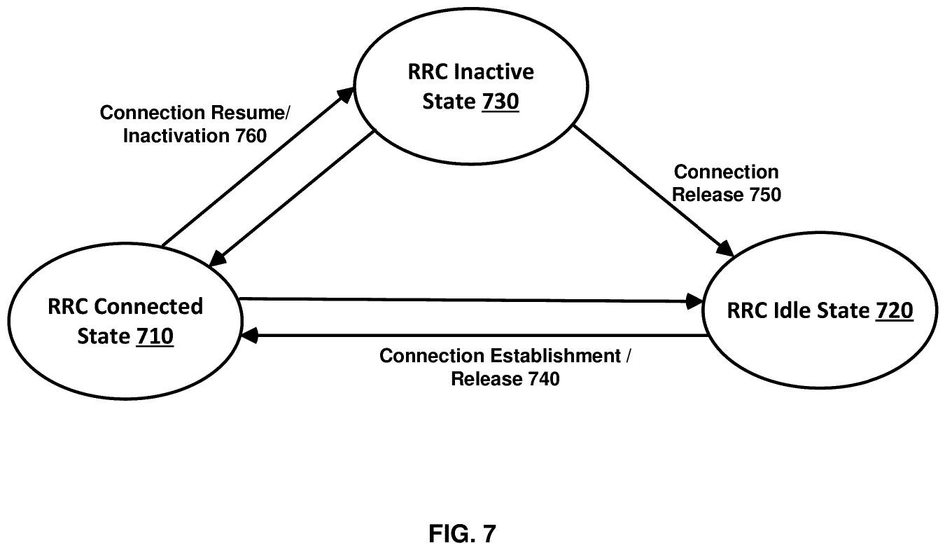

FIG. 7 shows examples of Radio Resource Control (RRC) states and transitioning between different RRC states according to some aspects of some of various exemplary embodiments of the present disclosure. A UE may be in one of three RRC states: RRC Connected State 710, RRC Idle State 720 and RRC Inactive state 730. After power up, the UE may be in RRC Idle state 720 and the UE may establish connection with the network using initial access and via an RRC connection establishment procedure to perform data transfer and/or to make/receive voice calls. Once RRC connection is established, the UE may be in RRC Connected State 710. The UE may transition from the RRC Idle state 720 to the RRC connected state 710 or from the RRC Connected State 710 to the RRC Idle state 720 using the RRC connection Establishment/Release procedures 740.

To reduce the signaling load and the latency resulting from frequent transitioning from the RRC Connected State 710 to the RRC Idle State 720 when the UE transmits frequent small data, the RRC Inactive State 730 may be used. In the RRC Inactive State 730, the AS context may be stored by both UE and gNB. This may result in faster state transition from the RRC Inactive State 730 to RRC Connected State 710. The UE may transition from the RRC Inactive State 730 to the RRC Connected State 710 or from the RRC Connected State 710 to the RRC Inactive State 730 using the RRC Connection Resume/Inactivation procedures 760. The UE may transition from the RRC Inactive State 730 to RRC Idle State 720 using an RRC Connection Release procedure 750.

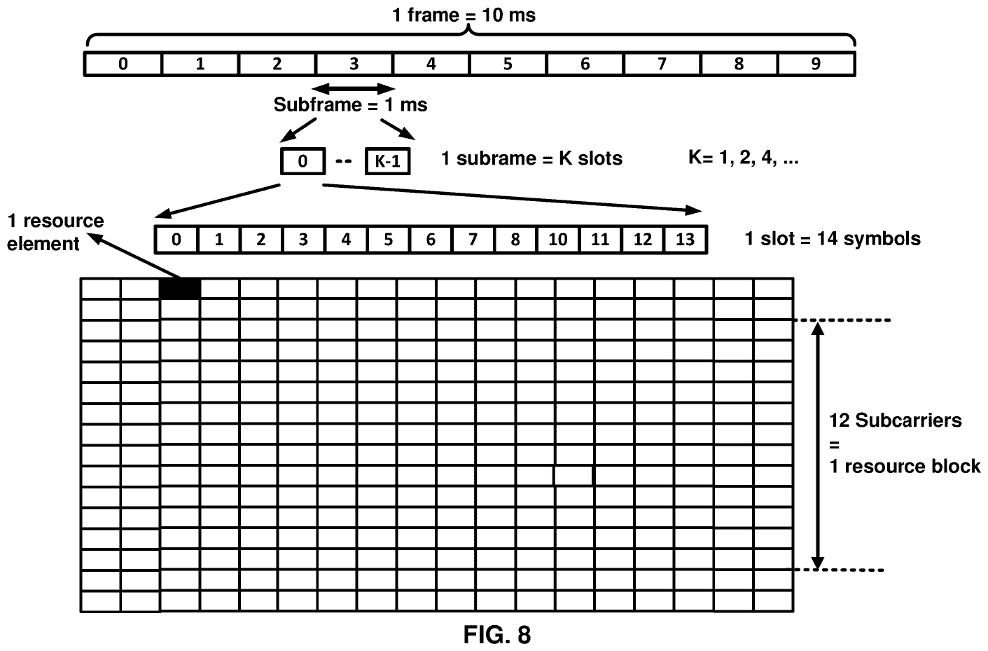

FIG. 8 shows example frame structure and physical resources according to some aspects of some of various exemplary embodiments of the present disclosure. The downlink or uplink or sidelink transmissions may be organized into frames with 10 ms duration, consisting of ten 1 ms subframes. Each subframe may consist of 1, 2, 4, . . . slots, wherein the number of slots per subframe may depend on the subcarrier spacing of the carrier on which the transmission takes place. The slot duration may be 14 symbols with Normal Cyclic Prefix (CP) and 12 symbols with Extended CP and may scale in time as a function of the used sub-carrier spacing so that there is an integer number of slots in a subframe. FIG. 8 shows a resource grid in time and frequency domain. Each element of the resource grid, comprising one symbol in time and one subcarrier in frequency, is referred to as a Resource Element (RE). A Resource Block (RB) may be defined as 12 consecutive subcarriers in the frequency domain.

In some examples and with non-slot-based scheduling, the transmission of a packet may occur over a portion of a slot, for example during 2, 4 or 7 OFDM symbols which may also be referred to as mini-slots. The mini-slots may be used for low latency applications such as URLLC and operation in unlicensed bands. In some embodiments, the mini-slots may also be used for fast flexible scheduling of services (e.g., pre-emption of URLLC over eMBB).

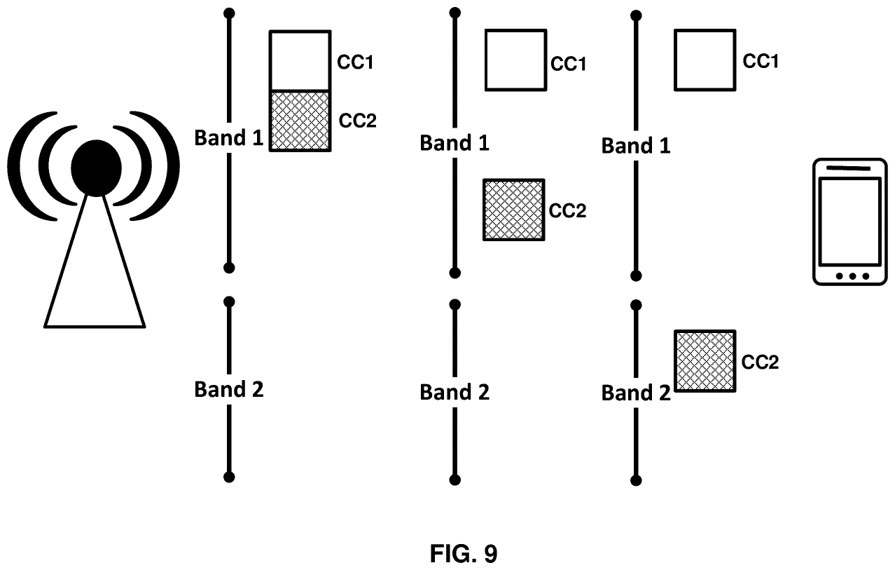

FIG. 9 shows example component carrier configurations in different carrier aggregation scenarios according to some aspects of some of various exemplary embodiments of the present disclosure. In Carrier Aggregation (CA), two or more Component Carriers (CCs) may be aggregated. A UE may simultaneously receive or transmit on one or multiple CCs depending on its capabilities. CA may be supported for both contiguous and non-contiguous CCs in the same band or on different bands as shown in FIG. 9. A gNB and the UE may communicate using a serving cell. A serving cell may be associated at least with one downlink CC (e.g., may be associated only with one downlink CC or may be associated with a downlink CC and an uplink CC). A serving cell may be a Primary Cell (PCell) or a Secondary cCell (SCell).

A UE may adjust the timing of its uplink transmissions using an uplink timing control procedure. A Timing Advance (TA) may be used to adjust the uplink frame timing relative to the downlink frame timing. The gNB may determine the desired Timing Advance setting and provides that to the UE. The UE may use the provided TA to determine its uplink transmit timing relative to the UE's observed downlink receive timing.

In the RRC Connected state, the gNB may be responsible for maintaining the timing advance to keep the L1 synchronized. Serving cells having uplink to which the same timing advance applies and using the same timing reference cell are grouped in a Timing Advance Group (TAG). A TAG may contain at least one serving cell with configured uplink. The mapping of a serving cell to a TAG may be configured by RRC. For the primary TAG, the UE may use the PCell as timing reference cell, except with shared spectrum channel access where an SCell may also be used as timing reference cell in certain cases. In a secondary TAG, the UE may use any of the activated SCells of this TAG as a timing reference cell and may not change it unless necessary.

Timing advance updates may be signaled by the gNB to the UE via MAC CE commands. Such commands may restart a TAG-specific timer which may indicate whether the L1 can be synchronized or not: when the timer is running, the L1 may be considered synchronized, otherwise, the L1 may be considered non-synchronized (in which case uplink transmission may only take place on PRACH).

A UE with single timing advance capability for CA may simultaneously receive and/or transmit on multiple CCs corresponding to multiple serving cells sharing the same timing advance (multiple serving cells grouped in one TAG). A UE with multiple timing advance capability for CA may simultaneously receive and/or transmit on multiple CCs corresponding to multiple serving cells with different timing advances (multiple serving cells grouped in multiple TAGs). The NG-RAN may ensure that each TAG contains at least one serving cell. A non-CA capable UE may receive on a single CC and may transmit on a single CC corresponding to one serving cell only (one serving cell in one TAG).

The multi-carrier nature of the physical layer in case of CA may be exposed to the MAC layer and one HARQ entity may be required per serving cell. When CA is configured, the UE may have one RRC connection with the network. At RRC connection establishment/re-establishment/handover, one serving cell (e.g., the PCell) may provide the NAS mobility information. Depending on UE capabilities, SCells may be configured to form together with the PCell a set of serving cells. The configured set of serving cells for a UE may consist of one PCell and one or more SCells. The reconfiguration, addition and removal of SCells may be performed by RRC.

In a dual connectivity scenario, a UE may be configured with a plurality of cells comprising a Master Cell Group (MCG) for communications with a master base station, a Secondary Cell Group (SCG) for communications with a secondary base station, and two MAC entities: one MAC entity and for the MCG for communications with the master base station and one MAC entity for the SCG for communications with the secondary base station.

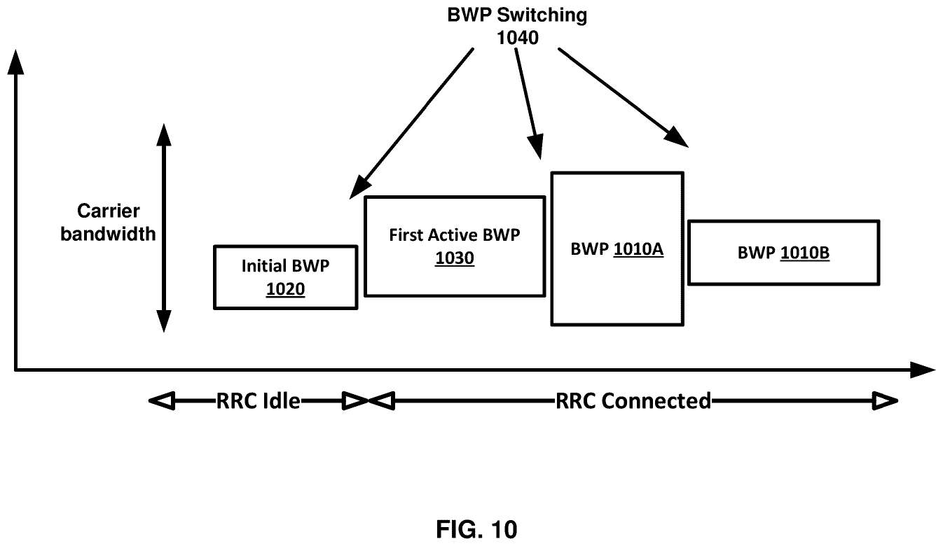

FIG. 10 shows example bandwidth part configuration and switching according to some aspects of some of various exemplary embodiments of the present disclosure. The UE may be configured with one or more Bandwidth Parts (BWPs) 1010 on a given component carrier. In some examples, one of the one or more bandwidth parts may be active at a time. The active bandwidth part may define the UE's operating bandwidth within the cell's operating bandwidth. For initial access, and until the UE's configuration in a cell is received, initial bandwidth part 1020 determined from system information may be used. With Bandwidth Adaptation (BA), for example through BWP switching 1040, the receive and transmit bandwidth of a UE may not be as large as the bandwidth of the cell and may be adjusted. For example, the width may be ordered to change (e.g. to shrink during period of low activity to save power); the location may move in the frequency domain (e.g. to increase scheduling flexibility); and the subcarrier spacing may be ordered to change (e.g. to allow different services). The first active BWP 1020 may be the active BWP upon RRC (re-)configuration for a PCell or activation of an SCell.

For a downlink BWP or uplink BWP in a set of downlink BWPs or uplink BWPs, respectively, the UE may be provided the following configuration parameters: a Subcarrier Spacing (SCS); a cyclic prefix; a common RB and a number of contiguous RBs; an index in the set of downlink BWPs or uplink BWPs by respective BWP-Id; a set of BWP-common and a set of BWP-dedicated parameters. A BWP may be associated with an OFDM numerology according to the configured subcarrier spacing and cyclic prefix for the BWP. For a serving cell, a UE may be provided by a default downlink BWP among the configured downlink BWPs. If a UE is not provided a default downlink BWP, the default downlink BWP may be the initial downlink BWP.

A downlink BWP may be associated with a BWP inactivity timer. If the BWP inactivity timer associated with the active downlink BWP expires and if the default downlink BWP is configured, the UE may perform BWP switching to the default BWP. If the BWP inactivity timer associated with the active downlink BWP expires and if the default downlink BWP is not configured, the UE may perform BWP switching to the initial downlink BWP.

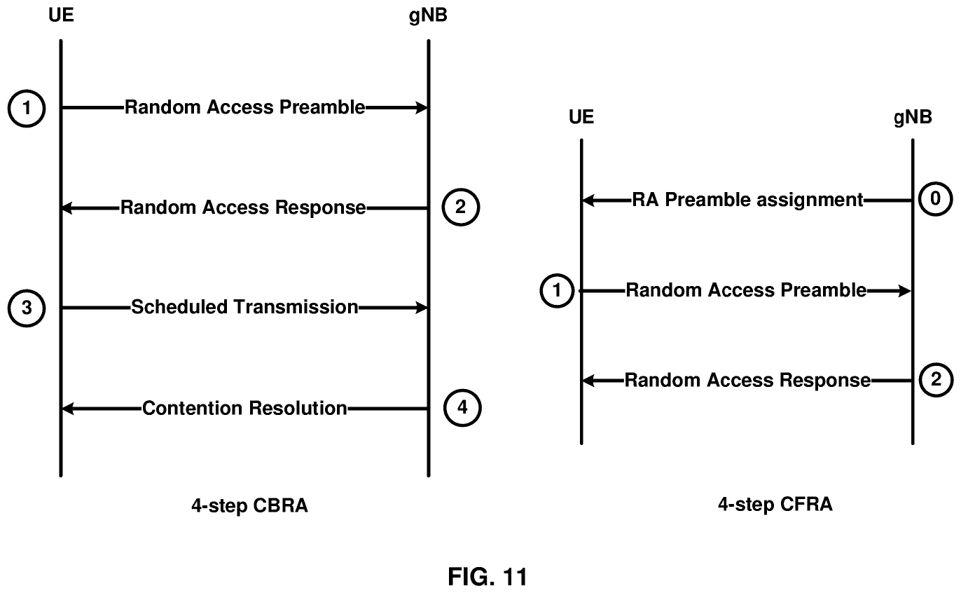

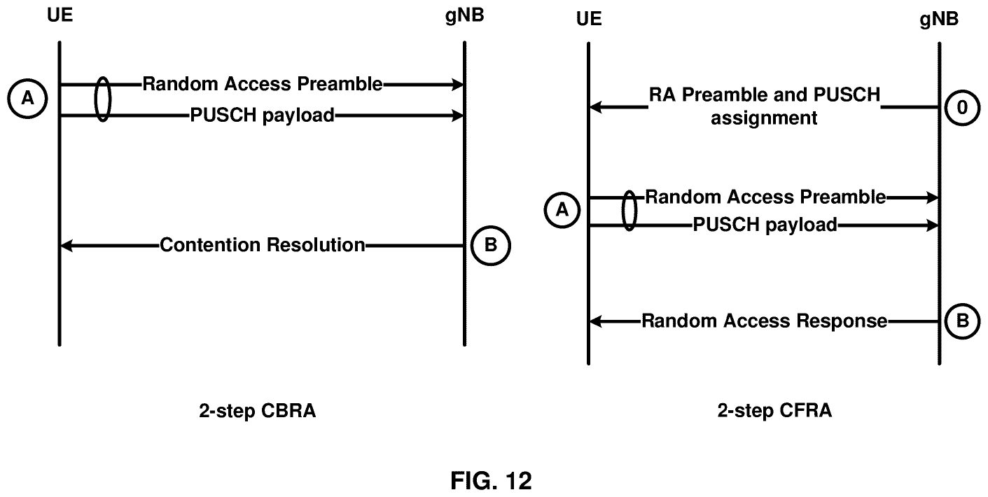

FIG. 11 shows example four-step contention-based and contention-free random access processes according to some aspects of some of various exemplary embodiments of the present disclosure. FIG. 12 shows example two-step contention-based and contention-free random access processes according to some aspects of some of various exemplary embodiments of the present disclosure. The random access procedure may be triggered by a number of events, for example: Initial access from RRC Idle State; RRC Connection Re-establishment procedure; downlink or uplink data arrival during RRC Connected State when uplink synchronization status is “non-synchronized”; uplink data arrival during RRC Connected State when there are no PUCCH resources for Scheduling Request (SR) available; SR failure; Request by RRC upon synchronous reconfiguration (e.g. handover); Transition from RRC Inactive State; to establish time alignment for a secondary TAG; Request for Other System Information (SI); Beam Failure Recovery (BFR); Consistent uplink Listen-Before-Talk (LBT) failure on PCell.

Two types of Random Access (RA) procedure may be supported: 4-step RA type with MSG1 and 2-step RA type with MSGA. Both types of RA procedure may support Contention-Based Random Access (CBRA) and Contention-Free Random Access (CFRA) as shown in FIG. 11 and FIG. 12.

The UE may select the type of random access at initiation of the random access procedure based on network configuration. When CFRA resources are not configured, a RSRP threshold may be used by the UE to select between 2-step RA type and 4-step RA type. When CFRA resources for 4-step RA type are configured, UE may perform random access with 4-step RA type. When CFRA resources for 2-step RA type are configured, UE may perform random access with 2-step RA type.

The MSG1 of the 4-step RA type may consist of a preamble on PRACH. After MSG1 transmission, the UE may monitor for a response from the network within a configured window. For CFRA, dedicated preamble for MSG1 transmission may be assigned by the network and upon receiving Random Access Response (RAR) from the network, the UE may end the random access procedure as shown in FIG. 11. For CBRA, upon reception of the random access response, the UE may send MSG3 using the uplink grant scheduled in the random access response and may monitor contention resolution as shown in FIG. 11. If contention resolution is not successful after MSG3 (re)transmission(s), the UE may go back to MSG1 transmission.

The MSGA of the 2-step RA type may include a preamble on PRACH and a payload on PUSCH. After MSGA transmission, the UE may monitor for a response from the network within a configured window. For CFRA, dedicated preamble and PUSCH resource may be configured for MSGA transmission and upon receiving the network response, the UE may end the random access procedure as shown in FIG. 12. For CBRA, if contention resolution is successful upon receiving the network response, the UE may end the random access procedure as shown in FIG. 12; while if fallback indication is received in MSGB, the UE may perform MSG3 transmission using the uplink grant scheduled in the fallback indication and may monitor contention resolution. If contention resolution is not successful after MSG3 (re)transmission(s), the UE may go back to MSGA transmission.

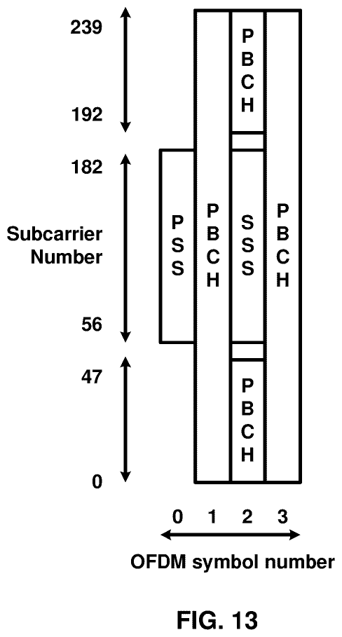

FIG. 13 shows example time and frequency structure of Synchronization Signal and Physical Broadcast Channel (PBCH) Block (SSB) according to some aspects of some of various exemplary embodiments of the present disclosure. The SS/PBCH Block (SSB) may consist of Primary and Secondary Synchronization Signals (PSS, SSS), each occupying 1 symbol and 127 subcarriers (e.g., subcarrier numbers 56 to 182 in FIG. 13), and PBCH spanning across 3 OFDM symbols and 240 subcarriers, but on one symbol leaving an unused part in the middle for SSS as show in FIG. 13. The possible time locations of SSBs within a half-frame may be determined by sub-carrier spacing and the periodicity of the half-frames, where SSBs are transmitted, may be configured by the network. During a half-frame, different SSBs may be transmitted in different spatial directions (i.e., using different beams, spanning the coverage area of a cell).

The PBCH may be used to carry Master Information Block (MIB) used by a UE during cell search and initial access procedures. The UE may first decode PBCH/MIB to receive other system information. The MIB may provide the UE with parameters required to acquire System Information Block 1 (SIB1), more specifically, information required for monitoring of PDCCH for scheduling PDSCH that carries SIB1. In addition, MIB may indicate cell barred status information. The MIB and SIB1 may be collectively referred to as the minimum system information (SI) and SIB1 may be referred to as remaining minimum system information (RMSI). The other system information blocks (SIBs) (e.g., SIB2, SIB3, SIB10 and SIBpos) may be referred to as Other SI. The Other SI may be periodically broadcast on DL-SCH, broadcast on-demand on DL-SCH (e.g., upon request from UEs in RRC Idle State, RRC Inactive State, or RRC connected State), or sent in a dedicated manner on DL-SCH to UEs in RRC Connected State (e.g., upon request, if configured by the network, from UEs in RRC Connected State or when the UE has an active BWP with no common search space configured).

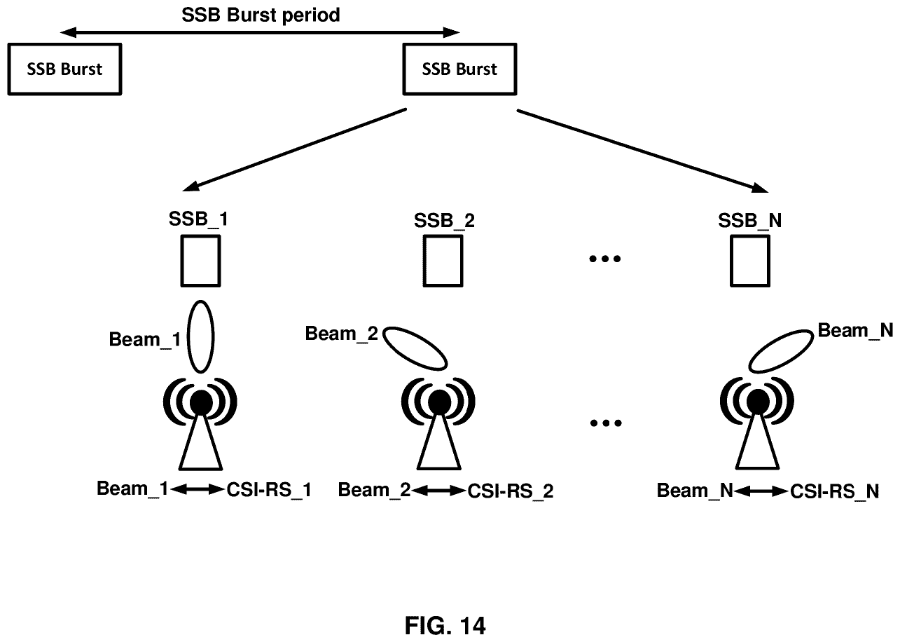

FIG. 14 shows example SSB burst transmissions according to some aspects of some of various exemplary embodiments of the present disclosure. An SSB burst may include N SSBs and each SSB of the N SSBs may correspond to a beam. The SSB bursts may be transmitted according to a periodicity (e.g., SSB burst period). During a contention-based random access process, a UE may perform a random access resource selection process, wherein the UE first selects an SSB before selecting a RA preamble. The UE may select an SSB with an RSRP above a configured threshold value. In some embodiments, the UE may select any SSB if no SSB with RSRP above the configured threshold is available. A set of random access preambles may be associated with an SSB. After selecting an SSB, the UE may select a random access preamble from the set of random access preambles associated with the SSB and may transmit the selected random access preamble to start the random access process.

In some embodiments, a beam of the N beams may be associated with a CSI-RS resource. A UE may measure CSI-RS resources and may select a CSI-RS with RSRP above a configured threshold value. The UE may select a random access preamble corresponding to the selected CSI-RS and may transmit the selected random access process to start the random access process. If there is no random access preamble associated with the selected CSI-RS, the UE may select a random access preamble corresponding to an SSB which is Quasi-Collocated with the selected CSI-RS.

In some embodiments, based on the UE measurements of the CSI-RS resources and the UE CSI reporting, the base station may determine a Transmission Configuration Indication (TCI) state and may indicate the TCI state to the UE, wherein the UE may use the indicated TCI state for reception of downlink control information (e.g., via PDCCH) or data (e.g., via PDSCH). The UE may use the indicated TCI state for using the appropriate beam for reception of data or control information. The indication of the TCI states may be using RRC configuration or in combination of RRC signaling and dynamic signaling (e.g., via a MAC Control element (MAC CE) and/or based on a value of field in the downlink control information that schedules the downlink transmission). The TCI state may indicate a Quasi-Colocation (QCL) relationship between a downlink reference signal such as CSI-RS and the DM-RS associated with the downlink control or data channels (e.g., PDCCH or PDSCH, respectively).

In some embodiments, the UE may be configured with a list of up to M TCI-State configurations, using Physical Downlink Shared Channel (PDSCH) configuration parameters, to decode PDSCH according to a detected PDCCH with DCI intended for the UE and the given serving cell, where M may depend on the UE capability. Each TCI-State may contain parameters for configuring a QCL relationship between one or two downlink reference signals and the DM-RS ports of the PDSCH, the DM-RS port of PDCCH or the CSI-RS port(s) of a CSI-RS resource. The quasi co-location relationship may be configured by one or more RRC parameters. The quasi co-location types corresponding to each DL RS may take one of the following values: ‘QCL-TypeA’: {Doppler shift, Doppler spread, average delay, delay spread}; ‘QCL-TypeB’: {Doppler shift, Doppler spread}; ‘QCL-TypeC’: {Doppler shift, average delay}; ‘QCL-TypeD’: {Spatial Rx parameter}. The UE may receive an activation command (e.g., a MAC CE), used to map TCI states to the codepoints of a DCI field.

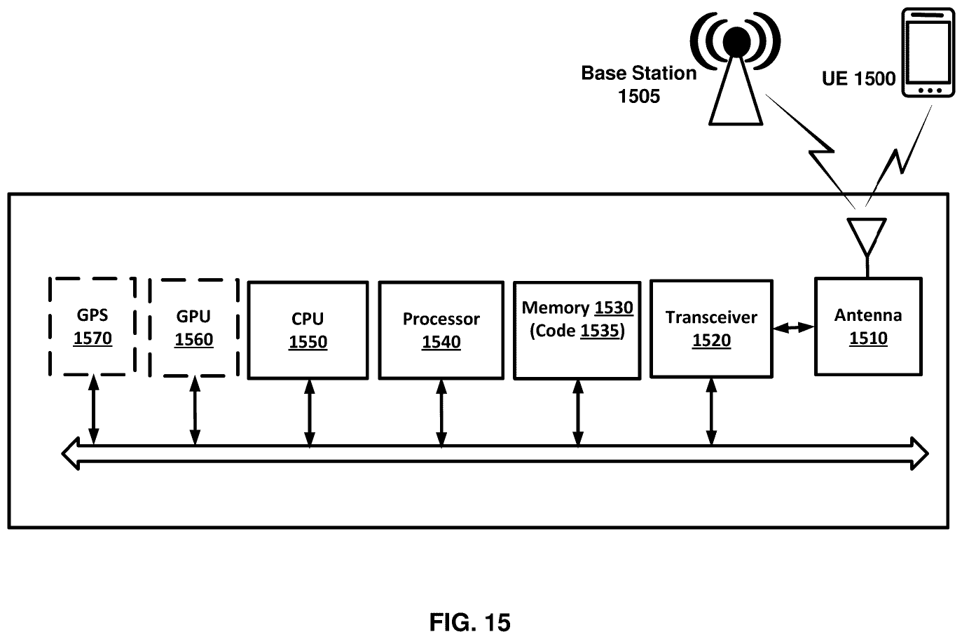

FIG. 15 shows example components of a user equipment and a base station for transmission and/or reception according to some aspects of some of various exemplary embodiments of the present disclosure. All or a subset of blocks and functions in FIG. 15 may be in the base station 1505 and the user equipment 1500 and may be performed by the user equipment 1500 and by the base station 1505. The Antenna 1510 may be used for transmission or reception of electromagnetic signals. The Antenna 1510 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 150 may enable a massive MIMO configuration with tens or hundreds of antenna elements. The Antenna 1510 may enable other multi-antenna techniques such as beamforming. In some examples, depending on the UE 1500 capabilities or the type of UE 1500 (e.g., a low-complexity UE), the UE 1500 may support a single antenna only.

The transceiver 1520 may communicate bi-directionally, via the Antenna 1510, wireless links as described herein. For example, the transceiver 1520 may represent a wireless transceiver at the UE and may communicate bi-directionally with the wireless transceiver at the base station or vice versa. The transceiver 1520 may include a modem to modulate the packets and provide the modulated packets to the Antennas 1510 for transmission, and to demodulate packets received from the Antennas 1510.

The memory 1530 may include RAM and ROM. The memory 1530 may store computer-readable, computer-executable code 1535 including instructions that, when executed, cause the processor to perform various functions described herein. In some examples, the memory 1530 may contain, among other things, a Basic Input/output System (BIOS) which may control basic hardware or software operation such as the interaction with peripheral components or devices.

The processor 1540 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1540 may be configured to operate a memory using a memory controller. In other examples, a memory controller may be integrated into the processor 1540. The processor 1540 may be configured to execute computer-readable instructions stored in a memory (e.g., the memory 1530) to cause the UE 1500 or the base station 1505 to perform various functions.

The Central Processing Unit (CPU) 1550 may perform basic arithmetic, logic, controlling, and Input/output (I/O) operations specified by the computer instructions in the Memory 1530. The user equipment 1500 and/or the base station 1505 may include additional peripheral components such as a graphics processing unit (GPU) 1560 and a Global Positioning System (GPS) 1570. The GPU 1560 is a specialized circuitry for rapid manipulation and altering of the Memory 1530 for accelerating the processing performance of the user equipment 1500 and/or the base station 1505. The GPS 1570 may be used for enabling location-based services or other services for example based on geographical position of the user equipment 1500.

In some examples, sidelink communication may be used to support advanced V2X applications. In some examples, the applicability of NR sidelink may be expanded to commercial use cases. For commercial sidelink applications, two key requirements have been identified: increased sidelink data rate and support of new carrier frequencies for sidelink. Increased sidelink data rate is motivated by applications such as sensor information (video) sharing between vehicles with high degree of driving automation. In some examples, increased data rate may be achieved with the support of sidelink carrier aggregation and sidelink over unlicensed spectrum. Furthermore, by enhancing the FR2 sidelink operation, increased data rate may be more efficiently supported on FR2. While the support of new carrier frequencies and larger bandwidths may allow to improve its data rate, the main benefit may come from making sidelink more applicable for a wider range of applications.

In an example V2X deployment scenario, both LTE V2X and NR V2X devices may coexist in the same frequency channel. For the two different types of devices to coexist while using a common carrier frequency, it is important that there is mechanism to efficiently utilize resource allocation by the two technologies without negatively impacting the operation of each technology.

In some examples, NR sidelink CA operation may be used. In some examples, SL carrier (re-)selection, synchronization of aggregated carriers, handling the limited capability, power control for simultaneous sidelink TX, Sidelink, first-stage SCI and second-stage SCI.

In some examples, sidelink control information (SCI) may comprise 1st stage SCI and 2nd stage SCI. The 1st stage SCI may be carried by the physical sidelink control channel (SCI) and the 2nd stage SCI may be transmitted by the physical sidelink shared channel (PSSCH).

In some examples, sidelink grants may be received dynamically on the PDCCH, configured semi-persistently by RRC or autonomously selected by the MAC entity. The MAC entity may have a sidelink grant on an active SL BWP to determine a set of PSCCH duration(s) in which transmission of SCI occurs and a set of PSSCH duration(s) in which transmission of SL-SCH associated with the SCI occurs. A sidelink grant addressed to SLCS-RNTI with NDI=1 may be considered as a dynamic sidelink grant.

In some examples, the TX resource (re-)selection check procedure may be triggered on the selected pool of resources for a Sidelink process. If PSCCH duration(s) and 2nd stage SCI on PSSCH for all transmissions of a MAC PDU of any selected sidelink grant(s) are not in SL DRX Active time of the destination that has data to be sent; or if SL RESOURCE RESELECTION COUNTER=0 and when SL RESOURCE RESELECTION COUNTER was equal to 1 the MAC entity randomly selected, with equal probability, a value in the interval [0, 1] which is above the probability configured by RRC in sl-ProbResourceKeep; or if the pool of resources is configured or reconfigured by RRC; or if there is no selected sidelink grant on the selected pool of resources; or if neither transmission nor retransmission has been performed by the MAC entity on any resource indicated in the selected sidelink grant during the last second; or if sl-ReselectAfter is configured and the number of consecutive unused transmission opportunities on resources indicated in the selected sidelink grant, which is incremented by 1 when none of the resources of the selected sidelink grant within a resource reservation interval is used, is equal to sl-ReselectAfter; or if the selected sidelink grant cannot accommodate a RLC SDU by using the maximum allowed MCS configured by RRC in sl-MaxMCS-PSSCH associated with the selected MCS table and the UE selects not to segment the RLC SDU; or if transmission(s) with the selected sidelink grant cannot fulfil the remaining PDB of the data in a logical channel, and the MAC entity selects not to perform transmission(s) corresponding to a single MAC PDU: the MAC entity may for the Sidelink process clear the selected sidelink grant associated to the Sidelink process, if available; and trigger the TX resource (re-)selection.

In some examples, SCI may indicate if there is a transmission on SL-SCH and may provide the relevant HARQ information. An SCI may consist of two parts: the 1st stage SCI on PSCCH and the 2nd stage SCI on PSSCH.

In some examples, for each PSCCH duration during which the MAC entity monitors PSCCH, if a 1st stage SCI has been received on the PSCCH: the MAC entity may determine the set of PSSCH durations in which reception of a 2nd stage SCI and the transport block occur using the received part of the SCI. If the 2nd stage SCI for this PSSCH duration has been received on the PSSCH: the MAC entity may store the SCI as a valid SCI for the PSSCH durations corresponding to transmission(s) of the transport block and the associated HARQ information and QoS information.

In some examples, for each PSSCH duration for which the MAC entity has a valid SCI, the MAC entity may deliver the SCI and the associated Sidelink transmission information to the Sidelink HARQ Entity.

In some examples, a channel may refer to a carrier or a part of a carrier consisting of a contiguous set of resource blocks (RBs) on which a channel access procedure is performed in shared spectrum.

In some examples, a channel access procedure, also referred to as listen-before-talk (LBT), may be a procedure based on sensing that evaluates the availability of a channel for performing transmissions. The basic unit for sensing may be a sensing slot with a duration Tₛₗ=9 us. The sensing slot duration Tₛₗ may be considered to be idle if an eNB/gNB or a UE senses the channel during the sensing slot duration and may determine that the detected power for at least 4 us within the sensing slot duration is less than energy detection threshold X_{Thresh}. Otherwise, the sensing slot duration Tₛₗ is considered to be busy.

In some examples, a channel occupancy may refer to transmission(s) on channel(s) by eNB/gNB/UE(s) after performing the corresponding channel access procedures.

In some examples, a Channel Occupancy Time (COT) may refer to the total time for which eNB/gNB/UE and any eNB/gNB/UE(s) sharing the channel occupancy perform transmission(s) on a channel after an eNB/gNB/UE performs the corresponding channel access procedures. For determining a Channel Occupancy Time, if a transmission gap is less than or equal to 25 us, the gap duration may be counted in the channel occupancy time. A channel occupancy time can be shared for transmission between an eNB/gNB and the corresponding UE(s).

Example embodiments enable enhancements to Stage 1 Sidelink Control Information (SCI) signaling to enable sidelink in unlicensed bands (SL-U) operation.

Example embodiments may enable expanding the applicability of NR Sidelink to other commercial use cases that may require increased Sidelink data rate and support of new carrier frequencies for Sidelink. Example embodiments may utilize carrier aggregation (CA) over Sidelink and operation of Sidelink in unlicensed/shared spectrum (SL-U). Example embodiments may enable enhancements needed in SL-U component carrier configuration and SCI signaling with primary focus on operation in unlicensed spectrum.

In some examples, the use and configurations SL may or may not be the same across all CCs within a RAN and UE's access to each of such SL-CCs may be restricted based on UEs capabilities, traffic priorities, load balancing and other considerations. In some examples, UEs may be allowed to operate on a subset of SL-U CCs. Such subset may be determined based on some rules, e.g., based on UE identifiers, capabilities, traffic types and/or priorities.

In some examples, the use of single or multiple carriers for SL-U depends on UE's capabilities, traffic type and network preferences.

In some examples, sidelink (Pre)Configuration and Signaling may support per CC radio configurations of usage and parameters, such as Bandwidth Part, SubCarrier Spacing (SCS), Resource Pool, control channel structure, access rules etc.

In some examples, in the frequency domain, a SL resource pool may be divided into a (pre-)configured number L of contiguous sub-channels, where a sub-channel may consist of a group of consecutive PRBs in a slot. The number Msub of PRBs in a sub-channel may correspond to the sub-channel size, which may be (pre-)configured within a resource pool. A sidelink transmission may use one or multiple sub-channels.

In some examples, SL-U may use notions of BWP, SL resource pool and resource block set (RBS). A SL BWP may be (pre-)configured within a carrier and may include one or multiple SL resource pools RPs.

In some examples, the SL-U may use frequency domain Block Interlaced Resources.

In some examples, the SL-U BWPs and Resource Pools may be aligned with Resource Block Sets (RBSs), e.g., 20 MHz LBT subbands expected for operation in unlicensed spectrum.

In some examples, SL-U may use Frequency domain Block Interlacing applied with each SL RBS.

In some examples, SL Resource Pools (RPs) may be aligned with, e.g., an integer number of, Resource Block Sets (RBSs), e.g., to enable 20 MHz LBT subbands.

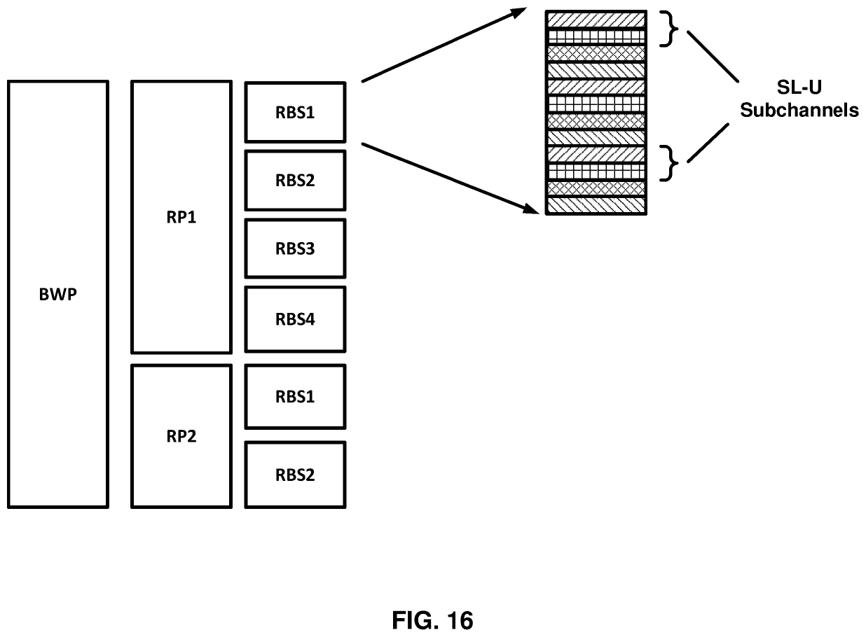

In some examples as shown in FIG. 16, notion of subchannels used in frequency domain resource reservation and allocation may be reused but with a different interpretation, so that each subchannel in SL-U is an integer configured set of Interlaces.

In some examples, frequency Domain Resource Reservation/Allocation in SL-U may be based on SL Subchannels, where subchannels may be configured to be integer number of Block Interlaces with interlacing is applied with each RBS.

In some examples, a two-part field in DCI may be used for wideband frequency domain resource allocation in the uplink. The first part, e.g., n bits, may point to a set of block interlaces based on RRC configured table and the second part may show the starting and number of consecutive RB Sets. The set of virtual resource blocks scheduled may be determined as the resource blocks forming the intersection of the selected interlaces and the selected resource-block sets.

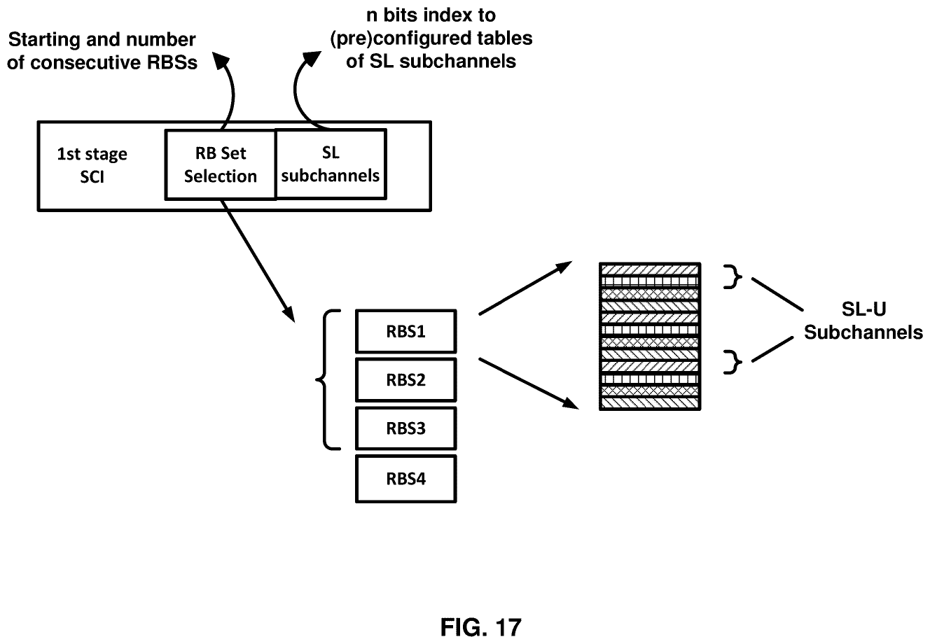

In some examples as shown in FIG. 17, for SL-U, Sidelink Control Information signaling may be used for signaling of wideband frequency domain resource reservation through using SL subchannels instead of block interlaces. In some examples, using two stage SCI transmission, the stage 1 SCI which may be used by all UEs for sensing may be designed to support such signaling.

In some examples, the 1st stage SCI in SL-U may include two-part field to show wideband Frequency Domain Resource Reservation, where the first part may point to a RRC configured set of Subchannels and second part may indicate starting and number of consecutive RBSs which are reserved.

In some examples, considering power saving is one of key objective in SL design, the control signaling may take into account power saving and reduce SCI monitoring by UEs. When SL-U is operating a on wideband CC and/or involving multiple Resource Block Sets (RBSs), UEs may need to monitor for possible Sidelink Control Information on multiple RBSs as part of their channel sensing and resource selection on Mode 2 resource allocation. The blind decoding of the 1st Stage SCIs may require processing and power consumption and performing such decoding on multiple RBSs may not power efficient and/or be supported by all UEs. To reduce such monitoring 5G NR sidelink may support transmission of 1st stage SCIs on a subset of SL RBSs.

In some examples, the subset of RBSs within a Resource Pool on which a 1st stage SCI may be transmitted on SL-U may be (pre) configured.

In some examples, slot based transmissions may simplify automatic gain control (AGC) and sensing based resources reservation/selection and may be used in SL-U as baseline.

In some examples, time resources allocations and reservation in SL-U may be slot based to simplify Automatic Gain Control, synchronization and resource allocation/reservation.

In some examples, slots that are part of a SL resource pool may be (pre-)configured and may occur with a periodicity of 10240 ms. The slots that are part of a resource pool may be (pre-)configured with a bitmap.

In some examples, for efficient channel access procedures in SL-U it may be beneficial to either not time share the same CC/BWP with NR-U on Uu link or to partition slots considering access and channel occupancy time (CoT) requirements. For example, time partitions may be configured such that both Uu and SL-U have access to slots within a Channel Occupancy Time (CoT). When such CC/BWP time sharing is needed, the same bit map approach, may be reused in configuring time resources within SL-U Resource Pools (RP).

In some examples, if an unlicensed CC/BWP is shared between SL and Uu link, a bitmap may be used to indicate time domain resources which are included in SL-U RP.

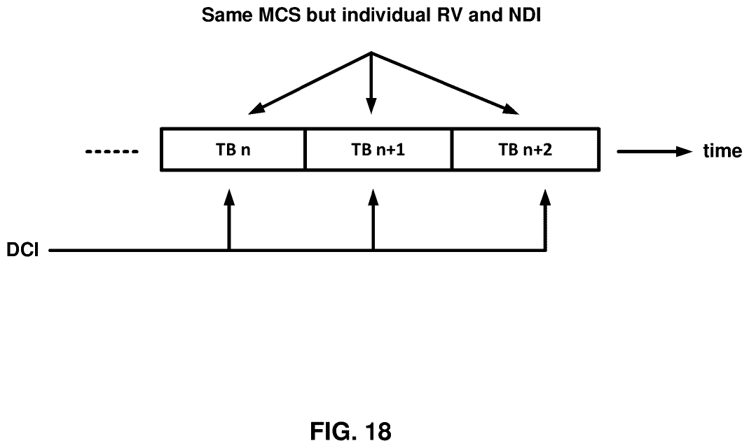

In some examples as shown in FIG. 18, given limited channel access and LBT requirement, NR-U may support multi-slot uplink resource allocation to transmit multiple TBs with a single DCI. The TBs transmitted back-to-back with the same MCS level but correspond to different HARQ processes and Redundancy Version. In some examples, in the case of SL-U for Mode 1 dynamic resource allocation set by the RAN a multi-slot SL allocation may be used that is similar to dynamic UL allocation in NR-U on Uu link.

In some examples, RAN scheduled Dynamic Resource allocation of SL-U the DCI may support single DCI signaling of multi-slot allocation similar to dynamic uplink scheduling in NR-U.

In some examples, for both Mode 1 and Mode 2 resource allocation, the 1st-stage SCI may indicate not only the frequency resources (e.g., sub-channels) of the PSSCH carrying the current (re)transmission of a TB, but also the resource reservation for up to two further retransmissions of the TB. The 1st-stage SCI may inform about the resource reservation period if the UE reserves resources semi-persistently for PSSCH. These capabilities may be extended with some design/configuration consideration in SL-U operation.

In some examples, Mode 2 may use almost the same procedure as Mode 1 to select resources for the dynamic and semi-persistent schemes. The differences may result from the fact that the dynamic scheme only selects resources for a TB while the semi-persistent scheme selects resources for a number of consecutive Reselection Counter TBs. In some examples, the time period between the resources selected for the transmission of consecutive TBs in the semi-persistent scheme is defined by the Resource Reservation Interval (RRI). The possible values of the RRI may be {0, [1:99], 100, 200, 300, 400 500, 600, 700, 800, 900, 1000} ms.

In some examples, given possibility of LBT failure Time Resource Reservation may be enhanced to allow extended time window for resource reservations across multiple slots within a COT and across multiple COTs. Such reservation may point to periodic windows within which TX UE may reserve resources to be use for transmission in response to LBT being successful. Even if time resources are reserved at slot level the PSSCH transmission may happen with flexible starting symbol, e.g. symbol 0 and symbol 7.

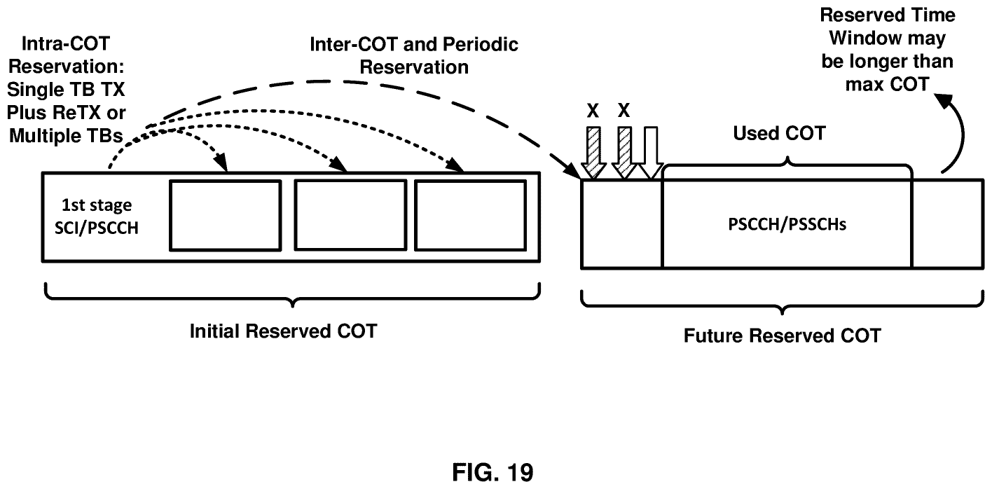

In some examples as shown in FIG. 19, SL-U resources reserved which may be within one COT may be protected from collision from other user transmission as both NR UE and other unlicensed devices may avoid using such resources. However, time resource reserved across COTs may be unavailable if TX UEs' proceeding LBT fails due to non-NR devices operating in the band.

In some examples, when operating on unlicensed spectrum, shared with other RATs like Wi-Fi, some of resources reserved by a TX UE may not be accessible and used due to LBT failure.

In some examples, time domain resources reserved within a CoT may be accessed with more certainty than those reserved across different CoTs.

In some examples, considering CoT and LBT impacts on Time Resource Reservation in SL-U the multiple options may be considered. In some examples, TX UEs may be limited for resource reservation to resources within a single COT. In some examples, TX UE may be used to reserve resources across multiple COTs.

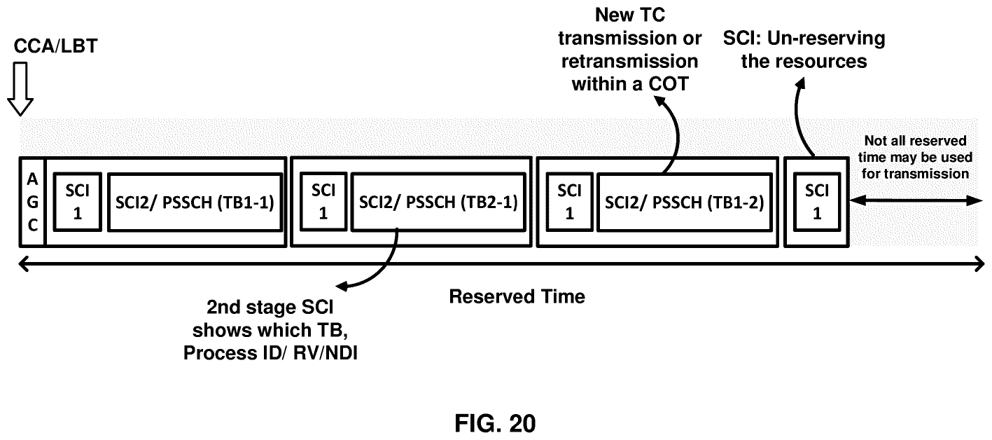

In some examples as shown in FIG. 20, the 1st Stage SCI may be used for resource reservation as it relates to sensing UEs while 2nd stage SCI may provide information about which TB is being transmitted or re-transmitted as it relevant to RX UEs only.

In some examples, for SL-U operation the 1st stage SCI may allow intra-CoT reservation of multiple slots to enable back-to-back (re)transmission of one or multiple TBs.

In some examples, for Inter CoT resource reservation, a TX UE may reserve a window of time resources longer than allowed CoT in SL-U but its actual transmission may not exceed the maximum allowed CoT.

In some examples, the 1st stage SCI may simply reserve multiple back-to-back slots within a CoT while 2nd Stage SCI may indicate which TB is being (re)transmitted, e.g., by including the Sidelink/HARQ Process ID, RV and NDI.

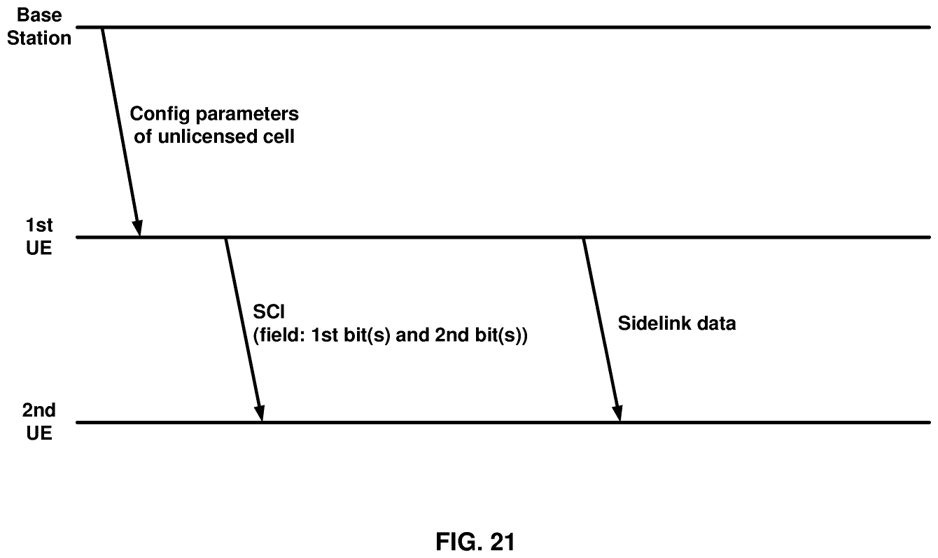

In some examples as shown in FIG. 21, TX UE may extend its resource reservation to span over the entire COT to allow sharing that COT with RX UEs or it may release/unreserve them if not used to that they can be used by other sensing UEs.

In some examples, if the TX UE's reserved resources are not used it may indicate their release, e.g., using an indication on 1st stage SCI, so that they can be used by other UEs.

In some examples, besides time and frequency resource reservation, the 1st-stage SCI includes the priority of the associated PSSCH, as well as the format and size of the 2nd-stage SCI. This capability may also be extended and aligned for service priorities and classes in NR-U which affect channel access, e.g., LBT, types and parameters.

In some examples, priority of PSSCH should be mapped to Channel Priority Access Classes (CPAC) in unlicensed spectrum which be used to determine parameters of LBT to be used.

Sidelink operation in unlicensed bands (SL-U) may be used to enhance sidelink data rates, support new carrier frequencies for sidelink, and to enable new applications. Existing sidelink control information (SCI) signaling may cause reduced efficiency and degraded performance for SL-U. There is a need to enhance existing SCI signaling when operation in unlicensed bands is configured for sidelink. Example embodiments enhance existing SCI signaling when operation in unlicensed bands is configured for sidelink.

In an example embodiment as shown in FIG. 21, a first UE may receive (e.g., from a base station) one or more messages (e.g., one or more RRC messages) comprising configuration parameters. The configuration parameters may comprise carrier configuration parameters of one or more carriers for sidelink communications by the first UE. The one or more carriers may comprise an unlicensed carrier. The configuration parameters may indicate/be associated with one or more bandwidth parts (BWPs) of the unlicensed carrier. The configuration parameters may indicate one or more of subcarrier spacing, usage scenarios, resource pool(s) (RP(s)), control channel structure of one or more BWPs of the unlicensed carrier. A BWP of the unlicensed carrier may comprise one or more RPs. A RP, in the one or more RPs, may comprise one or more resource block sets (RBSs). An RBS may be configured such that it is aligned with 20 MHz LBT bandwidth for channel access/LBT in unlicensed bands (e.g., to comply with the regulation requirements). The first UE may transmit (e.g., via configurable/based on one or more configuration (e.g., RRC configuration) parameters and/or via pre-configured resources) side control information (SCI) (e.g., a first-stage SCI in multi-stage SCI transmission) to a second UE. The SCI may comprise one or more fields. A field of the one or more fields may comprise one or more first bits and one or more second bits. A first value of the one or more first bits may indicate a set of subchannels of the unlicensed carrier. A second value of the one or more second bits may indicate a starting resource block set (RBS) and/or a number of consecutive RBSs in consecutive RBSs. The second value of the one or more second bits may indicate reservation of the consecutive RBSs (e.g., in unit of symbols, e.g., for one or more symbols). The first UE may initiate a sidelink transmission and may transmit, based on the SCI, one or more transport blocks to a second UE. For example, the first value of the one or more first bits and the second value of the one or more second bits may indicate and/or may be used to determine sidelink resources associated with the one or more transport blocks.

In some examples, the configuration parameters, received by the first UE, may indicate a plurality of sets of subchannels. The one or more first bits may indicate/point to/provide an index to the set of subchannels in the plurality of sets of subchannels.

In some examples, the unlicensed carrier may be shared between a Uu interface (e.g., between the first UE and the Base Station) and the sidelink (e.g., between the first UE and the second UE). In some examples the sharing may be in time domain. This sharing may be based on a bitmap (e.g., based on a configurable bitmap, e.g., based on a configuration parameter indicating the bitmap). The bitmap may indicate first time domain resources (e.g., one or more first symbols) that the unlicensed carrier is usable by the Uu interface and second time domain resources (e.g., one or more second symbols) that the unlicensed carrier is usable by the sidelink.

In some examples, the first UE may transmit a plurality of transport blocks in a plurality of slots/mini-slots based on a single DCI. The plurality of transport blocks may be associated with a single modulation and coding scheme (MCS). In some examples, the plurality of transport blocks may be associated with a plurality of HARQ process IDs. In some examples, the DCI may indicate a single HARQ process ID and the plurality of HARQ process IDs may be determined based on the single HARQ process ID indicated by the DCI. In some examples, the plurality of transport blocks may be associated with a plurality of redundancy versions (RVs). In some examples, the DCI may indicate a single HARQ process ID and the plurality of HARQ process IDs may be determined based on the single HARQ process ID indicated by the DCI.

In some examples, the first UE may reserve a plurality of resources with a time window (e.g., a time window that is based on channel occupancy time (COT), e.g., a COT obtained in response to successful LBT/channel access). In some examples, one or more parameters for the LBT/channel access may be based on a channel access priority class indicated by the control information. In some examples, the plurality of resources may be within a single COT. In some examples, the plurality of resources may be across multiple COTSs. In some examples, the SCI may be a first-stage SCI in multi-stage SCI transmission and may indicate reservation of multiple back-to-back slots for multiple TBs. The second-stage SCI of the multi-stage SCI transmission may indicate HARQ ID and/or RV and/or NDI associated with the multiple TBs. In some examples, the plurality of resources may be across multiple COTs (e.g., inter-COT reservation). The plurality of resources may be within a time window that is smaller than a threshold (e.g., a maximum allowed window for inter-COT reservation).

In an example embodiment, a first user equipment (UE) may receive configuration parameters of an unlicensed carrier for sidelink communications. The first UE may transmit, to a second UE, SCI comprising a field comprising one or more first bits and one or more second bits. The one or more first bits may indicate a set of subchannels of the unlicensed carrier. The one or more second bits may indicate at least one of a starting resource block set (RBS) and a number of consecutive RBSs. The first UE may transmit, to the second UE, sidelink data based on the SCI.

In some examples, the configuration parameters may be received from a base station (BS).

In some examples, the sidelink control information (SCI) may be a first-stage SCI in multi-stage SCI transmission.

In some examples, the configuration parameters may be for a plurality of carriers comprising the unlicensed carrier.

In some examples, the first UE may receive first configuration parameters indicating a plurality of sets of subchannels, wherein the one or more first bits may point to or may provide an index to the set of subchannel in the plurality of sets of subchannels.

In some examples, the configuration parameters may comprise first configuration parameters of a bandwidth part (BWP) of the unlicensed carrier. In some examples, the configuration parameters may indicate one or more of configuration of usage, subcarrier spacing (SCS), resource pool, control channel structure and access rules.

In some examples, the configuration parameters may indicate one or more resource pools (RPs) associated with the unlicensed carrier or associated with a bandwidth part (BWP) of the unlicensed carrier. In some examples, a resource pool (RP), in the one or more resource pools (RPs), may comprise one or more resource block sets (RBSs). In some examples, frequency domain block interleaving may be applied to a resource block set (RBS). In some examples, one or more resource block sets (RBSs) may be aligned with a 20 MHz subband for a listen-before-talk (LBT) process.

In some examples, the one or more second bits may indicate reservation of the consecutive resource block sets (RBSs). In some examples, the reservation of the consecutive resource block sets (RBSs) may be based on a unit of symbols.

In some examples, transmission of the side control information (SCI) may be via pre-configured resources.

In some examples, transmission of the side control information (SCI) may be via configurable resources. In some examples, the first UE may receive configuration parameters indicating the configurable resources.

In some examples, the configuration parameters may be received via one or more radio resource control (RRC) messages.

In some examples, the unlicensed carrier may be shared between a Uu interface and a sidelink. In some examples, the Uu interface may be between the first user equipment (UE) and a second UE. The sidelink may be between the first UE and a second UE. In some examples, a first configuration parameter of the configuration parameters may indicate a bitmap. The bitmap may indicate first time domain resources that the unlicensed carrier, or a first resource pool (RP) of the unlicensed carrier, is reserved for the Uu interface and second time domain resources that the unlicensed carrier, or the first RP, is reserved for the sidelink.

In some examples, the first user equipment (UE) may transmit a plurality of transport blocks based on a single downlink control information (DCI). In some examples, the plurality of transport blocks may be transmitted using the same modulation and coding scheme (MCS). In some examples, the first UE may determine a plurality of hybrid automatic repeat request (HARQ) process numbers for the plurality of transport blocks. In some examples, the downlink control information (DCI) may comprise a single hybrid automatic repeat request (HARQ) process number field, wherein determining the plurality of HARQ process numbers may be based on the value of the HARQ process number field. In some examples, the first UE may determine a plurality of redundancy versions (RVs) for the plurality of transport blocks. In some examples, the downlink control information (DCI) may comprise a single redundancy version (RV) field, wherein the determining the plurality of RVs may be based on the value of the RV field.

In some examples, the first user equipment (UE) may reserve a plurality of resources within a time window. In some examples, the time window may be based on a channel occupancy time (COT). In some examples, the channel occupancy time (COT) may be determined based on a listen-before-talk (LBT) process being successful. In some examples, the plurality of resources may be within a single channel occupancy time (COT). In some examples, a first-stage side control information (SCI) may indicate multiple slots to enable back to back transmission of multiple transport blocks. In some examples, a first-stage side control information (SCI) may indicate reservation of multiple back-to-back slots. In some examples, a second-stage SCI may indicate hybrid automatic repeat request (HARQ) process numbers and redundancy versions (RVs) and new data indicators (NDIs) for multiple transport blocks. In some examples, the plurality of resources may be across multiple channel occupancy times (COTs). In some examples, a time window, comprising the plurality of resources, may be smaller than a threshold.

In some examples, transmitting the sidelink data may be in response to a listen-before-talk (LBT) process. One or more parameters of the LBT process may be based on a channel access priority class associated with a physical sidelink shared channel used for transmission of the transport block.

The exemplary blocks and modules described in this disclosure with respect to the various example embodiments may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Examples of the general-purpose processor include but are not limited to a microprocessor, any conventional processor, a controller, a microcontroller, or a state machine. In some examples, a processor may be implemented using a combination of devices (e.g., a combination of a DSP and a microprocessor, multiple microprocessors, one or more microprocessors in conjunction with a DSP core, or any other such configuration).

The functions described in this disclosure may be implemented in hardware, software executed by a processor, firmware, or any combination thereof. Instructions or code may be stored or transmitted on a computer-readable medium for implementation of the functions. Other examples for implementation of the functions disclosed herein are also within the scope of this disclosure. Implementation of the functions may be via physically co-located or distributed elements (e.g., at various positions), including being distributed such that portions of functions are implemented at different physical locations.

Computer-readable media includes but is not limited to non-transitory computer storage media. A non-transitory storage medium may be accessed by a general purpose or special purpose computer. Examples of non-transitory storage media include, but are not limited to, random access memory (RAM), read-only memory (ROM), electrically erasable programmable ROM (EEPROM), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable media.

As used in this disclosure, use of the term “or” in a list of items indicates an inclusive list. The list of items may be prefaced by a phrase such as “at least one of” or “one or more of”. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

What is claimed is:

1. A method of sidelink control information (SCI) transmission, comprising the steps of:
receiving, by a first user equipment (UE), configuration parameters of an unlicensed carrier for sidelink communications;
first transmitting, by the first UE to a second UE, SCI comprising a field comprising one or more first bits and one or more second bits, wherein:
the one or more first bits indicates a set of subchannels of the unlicensed carrier; and
the one or more second bits indicate at least one of a starting resource block set (RBS) and a number of consecutive RBSs;
second transmitting, by the first UE to the second UE, sidelink data based on the SCI.

2. The method of claim 1, wherein the received configuration parameters are transmitted from a base station (BS).

3. The method of claim 1, wherein the sidelink control information (SCI) is first-stage SCI in a multi-stage SCI transmission.

4. The method of claim 1, wherein the configuration parameters are for a plurality of carriers comprising the unlicensed carrier.

5. The method of claim 1, further comprising the first user equipment (UE) receiving first configuration parameters indicating a plurality of sets of subchannels, wherein the one or more first bits point to or provide an index to the set of subchannels in the plurality of sets of subchannels.

6. The method of claim 1, wherein the configuration parameters comprise first configuration parameters of a bandwidth part (BWP) of the unlicensed carrier.

7. The method of claim 6, wherein the configuration parameters indicate one or more of configuration of usage, subcarrier spacing (SCS), resource pool, control channel structure and access rules.

8. The method of claim 1, wherein the configuration parameters indicate one or more resource pools (RPs) associated with the unlicensed carrier or associated with a bandwidth part (BWP) of the unlicensed carrier.

9. The method of claim 8, wherein a resource pool (RP) of the one or more resource pools (RPs) comprises one or more resource block sets (RBSs).

10. The method of claim 9, wherein frequency domain block interleaving is applied to a resource block set (RBS) of the one or more RBSs.

11. The method of claim 9, wherein one or more first resource block sets (RBSs) of the one or more RBSs, for which a listen-before-talk (LBT) process is applied, is aligned with a 20 MHz subband for the LBT process.

12. The method of claim 1, wherein the one or more second bits indicate reservation of the consecutive resource block sets (RBSs).

13. The method of claim 12, wherein the reservation of the consecutive resource block sets (RBSs) is based on a unit of symbols.

14. The method of claim 1, wherein transmission of the side control information (SCI) is via pre-configured resources.

15. The method of claim 1, wherein transmitting the side control information (SCI) is via configurable resources.

16. The method of claim 15, wherein the first user equipment (UE) further receives configuration parameters indicating the configurable resources.

17. The method of claim 1, wherein the configuration parameters are received by the first user equipment (UE) via one or more radio resource control (RRC) messages.

18. The method of claim 1, wherein the unlicensed carrier is shared between a Uu interface and a sidelink.

19. The method of claim 18, wherein:
the Uu interface is between the first user equipment (UE) and a base station; and
the sidelink is between the first UE and a second UE.

20. The method of claim 18, wherein:
a first configuration parameter of the configuration parameters indicate a bitmap; and
the bitmap indicates first time domain resources that the unlicensed carrier, or a first resource pool (RP) of the unlicensed carrier, is reserved for the Uu interface and second time domain resources that the unlicensed carrier, or the first RP, is reserved for the sidelink.
